(19) United States
(12) Patent Application Publication
(10) Pub. No.: US 2024/0257991 A1
(43) Pub. Date: Aug. 1, 2024

(54) FORMATION OF ELECTRICALLY CONDUCTIVE LAYERS AT NEAR AMBIENT TEMPERATURE USING SILVER NANOPARTICULATE PROCESSING AND INKS FOR FORMING THE LAYERS

(71) Applicant: C3 Nano, Inc., Hayward, CA (US)

(72) Inventors: Xiqiang Yang, Hayward, CA (US); Arthur Yung-Chi Cheng, Newark, CA (US); Michael Fang, Hayward, CA (US); Pei-Kang Liu, Claremont, CA (US); Ajay Virkar, San Mateo, CA (US)

(21) Appl. No.: 18/422,732

(22) Filed: Jan. 25, 2024

Related U.S. Application Data
(60) Provisional application No. 63/441,671, filed on Jan. 27, 2023.

(51) Int. Cl. H01B 1/02

(52) U.S. Cl. CPC H01B 1/02

(57) ABSTRACT

Near ambient temperature processing has successfully resulted in highly conductive coatings formed from silver nanowires. The electrically conductive materials can have a high loading of silver and low resistivities. The highly conductive materials can be formed using aqueous inks with high loadings of silver nanowires with greater than 3 wt % metal that is primarily silver nanowires. Methods of preparing the high loading inks can comprise forming a good dispersion of the silver nanowires and removing solvent to concentrate the dispersions. A range of binders can be used including, for example, UV crosslinkable binders. Generally, the organic concentration of the highly conductive materials is no more than 25 wt %, although this can correspond to higher volume fractions of organics while still achieving good electrical conduction.

### CROSS REFERENCE TO RELATED APPLICATIONS

This application claims priority to copending U.S. provisional patent application 63/441,671 filed Jan. 27, 2023 to Yang et al., entitled “Formation of Electrically Conductive Layers at Near Ambient Temperature Using Silver Nanoparticlulate Processing and Inks for Forming the Layers,” incorporated herein by reference.

### FIELD OF THE INVENTION

The invention relates to near ambient temperature processing to form thin electrically conductive coatings, which may be transparent. The invention further relates to some silver nanowire inks for forming electrically conductive coatings as well as electrically conductive coatings on temperature sensitive substrates.

### BACKGROUND OF THE INVENTION

Functional films can provide important functions in a range of contexts. For example, electrically conductive layers can be important for the dissipation of static electricity when static can be undesirable or dangerous. Transparent conductive films can be used as electrodes. High quality displays can comprise one or more transparent conductive layers.

Transparent conductors can be used for several optoelectronic applications including, for example, touch-screens, liquid crystal displays (LCD), flat panel display, organic light emitting diode (OLED), solar cells and smart windows. Historically, indium tin oxide (ITO) has been the material of choice due to its relatively high transparency at high conductivities. There are however several shortcomings with ITO. For example, ITO is a brittle ceramic, which needs to be deposited using sputtering, a fabrication process that involves high temperatures and vacuum and therefore is relatively slow and not cost effective. Additionally, ITO is known to crack easily on flexible substrates. Newer portable electronic devices are pushing into thinner formats and flexible formats.

Other applications use non-transparent conductors with much higher conductivities than ITO for a myriad of functions including, for example, circuits, interconnects, conductive traces, bezels, shielding, heat dissipation or sinks, or the like. It is desirable to create such metal conductive films, circuits or elements from an ink which can be deposited via many methods and can be processed at lower temperatures which can increase the range of potential compatible surface and structures which can be electrified and can reduce overall cost of manufacturing.

### SUMMARY OF THE INVENTION

In a first aspect, the invention pertains to an electrically conductive composite material comprising at least about 75 weight percent (wt %) silver particulates and polymer binder, and the silver particulates comprise at least about 67 wt % silver nanowires having an aspect ratio of at least about 75. The polymer binder may be included in an amount of at least about 2 wt % of the electrically conductive composite material. The electrically conductive composite material can have a resistivity of no more than about 5×10⁻³ Ohm-cm.

In a second aspect, the invention pertains to an electrically conductive structure comprising the electrically conductive composite material, and the structure has a transmittance of visible light of no more than about 70%. The electrically conductive structure can comprise a layer having an average thickness of from about 0.2 microns to about 2 millimeters, or a layer having an average thickness of no more than about 5 microns and a sheet resistance of no more than about 5 Ohms/sq. The electrically conductive structure can comprise the electrically conductive composite material disposed on a heat sensitive substrate unstable over about 100° C. The electrically conductive structure can comprise the electrically conductive composite material which has been processed at temperatures below about 100° C.

In another aspect, the invention pertains to an ink for forming an electrically conductive deposit. The ink can comprise an aqueous solvent and at least about 3 wt % metal particulates comprising at least about 67 wt % silver nanowires. The ink can be stable against visible settling for at least 24 hours without agitation. The ink can comprise from about 3 wt % to about 20 wt % metal particulates comprising at least about 67 wt % silver nanowires. The ink can form a conductive material upon removal of the aqueous solvent.

In another aspect, the invention pertains to a method for forming an ink for forming an electrically conductive deposit, the method comprising: forming a good solvent blend dispersion of silver nanowires having a concentration of no more than about 2.5 wt %, wherein the solvent comprises at least about 20 volume percent alcohol with a boiling point of no more than about 99° C.; and removing solvent to concentrate the good solvent blend dispersion to form an aqueous dispersion having at least about 3 wt % silver nanowires. The good solvent blend dispersion can be stable against any significant settling for at least 3 months in a sealed environment preventing solvent evaporation or contamination.

In another aspect, the invention pertains to a method for forming an electrically conductive composite material, the method comprising: casting an ink comprising a solid content that has from about 75 wt % to about 98 wt % silver particulates and least about 2 wt % polymer binder precursors, wherein the silver particulates comprise at least about 67 wt % silver nanowires having an aspect ratio of at least about 75, to form a casted structure and curing the cast structure to form the electrically conductive composite material. Curing can be performed at temperatures of no more than about 100° C.

In another aspect, with respect to highly conductive, opaque structures, the invention pertains to a substrate with a deposit comprising metal nanowires having an average thickness of no more than about 5 microns, a sheet resistance of no more than about 5 Ohms/sq and a resistivity of no more than about 5×10⁻³ Ohms-cm. The deposit can comprise other metal nanoparticulates in addition to the metal nanowires. In some embodiments, the metal nanowires make up at least about 10 weight percent of the metal nanoparticulates. The deposit can comprise polymer binder such that metal content of the deposit is from about 75 wt % to about 99 wt %. The polymer binder can comprise a polysaccharide to assist with forming a good coatable dispersion and/or a UV crosslinkable resins or polymers to improve the mechanical stability.

In some aspects, the invention pertains to an ink comprising a polar solvent, which in some embodiments comprises at least 80 weight percent water, and at least about 3 weight percent metal nanoparticulates comprising metal nanowires, wherein the ink is stable against visible settling for at least 24 hours without agitation. Moreover, the inks are appropriately stable and retains its overall properties and performance for days, weeks or longer when stored at room temperatures. and overcomes the general issue of poor stability, which can be associated with considerable settling, irreversible aggregate formation, inadvertent metal plating associated with highly reactive metal deposition precursor or other instability issues from attempts to introduce good conduction at ambient temperatures.

### BRIEF DESCRIPTION OF THE DRAWINGS

FIG. 1 is a fragmentary side view of a film with a conductive layer and various additional transparent layers on either side of the conductive layer.

FIG. 2 is a schematic plot showing relative differences in processing temperature versus time, energy and cost, for contemporary electrode technologies.

FIG. 3 is a plot of percent total transmittance as a function of sheet resistance for ink coatings including AgF and dried at ambient conditions.

FIG. 4 is a plot of percent haze as a function of sheet resistance for an ink coating including AgF and dried at ambient conditions.

FIG. 5A is a photograph showing measurement of resistance for an ink coating of the present invention, on a medical grade polyurethane substrate, dried at ambient conditions.

FIG. 5B is a photograph showing measurement of resistance for an ink coating of the present invention, on a medical bandage, dried under ambient conditions.

FIG. 5C is a photograph showing measurement of resistance for an ink coating of the present invention, on a leaf, dried under ambient conditions.

FIG. 5D is a photograph showing measurement of resistance for an ink coating of the present invention, on a Ziploc® bag, dried under ambient conditions.

FIG. 5E is a photograph showing measurement of resistance for an ink coating of the present invention, on a shrink wrap substrate, dried under ambient conditions.

FIG. 5F is a photograph showing measurement of resistance for an ink coating of the present invention, on the adhesive layer of a Scotch™ Tape substrate, dried under ambient conditions.

FIG. 5G is a photograph showing measurement of resistance for an ink coating of the present invention, formed as a circuit on a polyethylene terephthalate substrate, dried under ambient conditions.

FIG. 5H is a photograph showing measurement of resistance for an ink coating of the present invention, formed as a circuit on a packaging cardboard substrate, dried under ambient conditions.

### DETAILED DESCRIPTION OF THE INVENTION

Readily processable silver nanowire containing inks can be formed into highly electrically conductive material at room temperature. As described herein, the conductive materials can form opaque structures with very low resistances. For high loading opaque materials, good electrical conductivity can be achieved with or without fusing the nanowires, but fusing generally is desirable to form transparent coatings with good mechanical properties, improved stability and better optical characteristics. The high loading nanoparticulate structures achieve metallic like properties even without fusing the structure while having a significant volume fraction of organics. Depending on the structures formed, fusing with reduced metal salts may or may not improve conductivity, but the effects generally are not large. Processing for the formation of transparent conductors generally involves inks containing an appropriate amount of polysaccharide binders, such as cellulose ethers, and/or other binders, such as UV crosslinkable polymers, monomers, oligomers or resins. For low transmittance or fully opaque embodiments, low levels of polymer binders have been found to be effective to form conductive structures with a high density of silver and low electrical resistance. Polymer binders are solid compositions, but they can be delivered from the inks as dissolved polymers or resins that solidify upon drying and are optionally crosslinked, or as liquid monomers, oligomers or liquid polymers, with optional compatible solvent, that are polymerized and/or crosslinked to form the solid polymer binder. Deposits of reduced metal/silver may or may not be used to increase metal connectivity to improve electrical conductivity. The nanowire aspect ratio seems significant with respect to establishing high electrical conductivity. Other silver particulates can be added to supplement to the metal species, but a majority of silver nanowires should be used to impart high conductivity to structures formed at low (near ambient) temperatures.

To obtain higher degrees of conductivity and correspondingly lower resistivities, the amount of polymer binder is lowered. The understanding from the present work is that the sparse layers involve specific challenges for establishment of conductive pathways. These challenges can be overcome through the use of compatible organics, such as polymers. In particular polyol polymers to help with nanowire placement and of nanowire junctions to establish a unitary structure with corresponding good conductivity along an interconnected network. Surprisingly, the high metal loading materials self-pack to establish good connectivity and fusing may or may not be effective to further boost conductivity. Such high conductivity results are not found with high loading of spherical silver particles that require fusing to establish highly conductive materials. The high loading silver nanowire materials can be processed at room temperature, or comparable low temperatures to achieve a desired drying time. Since fusing, which in present context involves the reduction of metal ions and complexes into metallic deposits which chemically, physically, and electrically connect metal particles, is generally not involved in the basic processing of the high loading composites described herein, process times can be low, on the order of a few minutes. Deposition of reduced metal can be performed, and slight improvement or degradation of electrical conductivity have been observed, so small improvement from metal deposition should be achievable. If silver or other metal ions are reduced to deposit metal in the composite, it is not clear whether or not a fused interconnected structure is formed. If no metal is reduced and deposited, the silver particles remain as discrete particulates although bound within the polymer binder. Fast and, low temperature or room temperature processing can offer important advantages for applications where these parameters allow for previously unachievable process speeds or use of desired materials that were contraindicated under different process conditions.

It has been discovered that relatively high silver concentration inks can be formed and are stable with concentrations over 2 weight percent. In some embodiments, the inks may be amenable to various coating processes, such as slot coating, dip coating, spray or jet-deposition, and/or the like, and can be applied to a range of substrate surfaces. Moreover higher viscosity inks can be formed from higher concentration NWs based precursing inks, which can be amenable to processing like printing, jetting, screen-printing, and the alike. Processing to form the high concentration silver nanowire inks can comprise forming a dilute dispersion and evaporating solvent to achieve a desired concentration. Alternative solvents can be blended if they have a higher boiling point than original solvent of the more dilute dispersion. For the formation of opaque, low electrical resistance structures, it has been found that high particle loading can be achieved with at most low levels of polymer binder and no fusing, with evidence suggesting a transition to a distinct conduction mechanism. This material has high metal density of greater than 25% of the bulk density. Viewed another way, the deposit can have at least 25 volume percent silver metal with the remainder of the volume occupied by polymer binder, resins, other organics, such as process aids, surfactants and the like, and potentially pores. While the metal nanowires contribute to the conductive nature through their ability to form conduction points at multiple locations, for less transparent materials, other metal particulate shapes can also be incorporated to the conductive structure. The room temperature processing and/or high particle loadings can advantageously open the processing to a range of previously inappropriate substrate materials and can also provide energy saving, notably simplified processing procedures and associated cost savings. Some substrate materials may be unstable over a certain temperature, such as over 100° C., over 125° C., or over 150° C., and most organic polymers decompose at a temperature below 800° C. Instability can be manifested by losing mechanical stability, such as by curling, chemical stability, such as decomposition of the polymer, combinations thereof, or the like. A person of ordinary skill in the art will recognize that additional ranges of instability temperatures within the explicit ranges above are contemplated and are within the present disclosure.

Silver nanowires have been successfully produced into high optical quality transparent conductive coatings with desirable mechanical properties, such as stretchability and stability against repeated folding and unfolding, while maintaining electrical conductivity. Processing extensions described herein can maintain the excellent optical qualities as well as extend desirable processing of conductive coatings for formation of less transparent or nontransparent conductive thin films. Dispersions or inks of silver nanowires can be deposited on a surface and processed into a conductive coating. Under appropriate process conditions, a resulting conductive coating, optionally transparent, can be desirable due to its mechanical properties, such as flexibility, formability, combinations of these features, or other aspects of the conductive coating. In the art, “nanoparticle” has taken on extra duty to refer specifically to roughly spherical nanostructures as well as to refer to nanostructures of any shape. To lessen the burden on this term, herein “nanoparticulate” is used to refer to nanostructures of any shape, and “nanoparticle” refers only to roughly spherical nanostructures, i.e., ratios of diameters along the three principal axes are on average less than about 2. With respect to transparent coatings, the use of the nanowires to form transparent conductive coatings can have significant application in devices with displays and touch sensors. With higher metal loadings, reduced electrical resistance is found, while the transmittance of visible light is reduced. Even well purified silver nanowires have some minor portion of other silver nanoparticulate contaminants. and in the context of less transparent or non-transparent applications, the nanowires may be mixed with somewhat greater weight fraction of other nanoparticulates. It has also been discovered that these concepts can be extended further into the opaque range wherein even higher loading of metal can achieve lower resistivities. To achieve dense metal nanoparticulate deposits, it has been discovered how to form stable dispersions in a polar solvent with high concentrations of metal nanoparticulates comprising metal nanowires. Other polar solvents (for example alcohols) are also suitable solvents to achieve high concentrations of metal nanowires.

With the formation of transparent conductive films, sparse metal conductive layers are formed where light can transmit through the layer since the nanowires generally have diameters less than the wavelength of light and gaps between the nanowires provide for passage of the light. With good contact between the silver nanowires and sufficient loading, a percolation mechanism can be used to explain the electrical conduction path. Applicant discovered that fusing of the nanowires into a unitary structure allows for direct conduction of electricity through the structure without substantial junction resistance suggesting an avoidance of a percolation process. While not wanting to be limited by theory, the results herein suggest that for highly loaded silver nanowires, the material has a metallic character suggestive of overlapping conduction orbitals extending through the material even with a significant volume fraction of organics surrounding the metal nanowires. Moreover, as the number of connections/junctions increases, the overall series resistance of a film decreases in a manner analogous to the well-known macroscopic case of parallel resistors. The nanowire aspect ratio seems to contribute to this electrical conduction property, although the silver nanowires can be supplemented or partially replaced with other silver nanoparticulates. The materials can be process from silver nanowire inks at room temperature, although heating can be used. The use of reducible metal salts and complexes, i.e., Nanoglue™, may or may not improve electrical conductivity and may be used if desired. With some metal salts, some heating may be desirable. Low resistivity values have been obtained with room temperature processing.

With the capability of processing at room temperature, formation of non-transparent conductive layers can be desirably formed on a temperature sensitive substrate. Inclusion of additional nanoparticles may be desirable to improve conductivities or reduce costs (less purification) for optically insensitive coatings. Thus, the processing described herein may be practically applied to a broader range of applications of electrically conductive coatings. The room temperature processing of transparent and translucent conductive films is described in copending U.S. patent application Ser. No. 18/212,297 to Yang et al., entitled “Formation of Electrically Conductive Layers at Room Temperature Using Nanoparticulate Processing and Inks for Forming the Layers,” incorporated herein by reference. Of course, to increase the conductivity or decrease the resistance of the structure, the thickness of the silver nanowire/nanoparticulate coating can be increased and/or multiple layers can be added. What is discovered here is that with appropriate processing and nanoparticulate selection a material can be formed with unique and amazing electrical conduction properties. The materials with a significant volume fraction of polymer binders can exhibit a resistivity comparable to tin metal or lead metal. Clearly, such material can be a solder replacement that has very low toxicity and is room temperature processable.

The one-dimensional morphology of nanowires is conducive to forming sparse metal conductive layers, as well as a fused metal nanostructured network, which has been found to exhibit desirable electrical, optical and mechanical properties. For forming transparent conductive films, Applicant's application of the fusing process can be controlled to selectively deposit metal at junctions between the metal nanowires or to form a fused mass for less conductive structures regardless of the nanoparticulates. In the fused structure, unlike the unfused structure, electrons can conduct through the network instead of hopping between separate nanowires. The one dimensional morphology of the silver nanowires seems to contribute in significant ways to the conduction properties of the discovered highly conductive materials described herein, even though the materials are not sparse and transparent. Conductivity referenced herein refers to electrical conductivity unless specifically indicated otherwise. However, it should also be noted that highly electrically conductive structures and composites are also generally expected to have high thermal conductivities as both thermal and electrical conductivities are related to electron kinetic energies which can often be more dominant that phonon transport in metallic systems.

In Applicant's prior work based on thermodynamically driven fusing, this processing was performed at low temperature in a relative sense. Heat though was used to control drying rate and to control the fusing process and to accelerate other kinetic processes, reaction rates and diffusion. In the context of commercial processing of conductive films, roll-to-roll processing was developed using existing process equipment to provide desired heating with consistent product quality, and the modest heating was straightforward to implement. Nevertheless, the heating does consume energy and does provide constraints on substrates. In particular, a myriad of plastic, polymeric, and biologically relevant substrates exhibit low glass transition and or low melting temperatures which require low processing temperatures.

When faced with processing of particularly heat sensitive substrates, an effort was made to lower the process temperature. Surprisingly, systems were developed that achieved low sheet resistances with room temperature processing with a single ink deposition and with fast results. These results are again consistent with poised thermodynamic systems that can be guided to achieve desired results with appropriately tuned chemical combinations, which were discovered as described herein. With the achievement of these results, it was recognized that desirable processing improvements could also be applicable to applications with less demanding optical properties or even non-transparent applications with advantageous effect.

As the results presented herein demonstrate, the composition of the silver nanowire inks determines the effectiveness of forming a good conductive layer with or without fusing of the nanowires into a fused metal nanostructure network or other fused conductor, and at temperatures no more than about 60° C., in additional embodiments no more than about 55° C., in other embodiments no more than about 50° C., in some embodiments no more than about 40° C., and in further embodiments no more than about 30° C., especially at room temperature. For the purposes herein, room temperature can be considered to be from about 16° C. to about 28° C., although in some embodiments it may be appropriate to consider a range for room temperature to be from about 18° C. to about 26° C., from about 20° C. to about 25° C. or other appropriate subranges within the broad range provided. A person of ordinary skill in the art will recognize that additional ranges of temperature within the explicit ranges above are contemplated and are within the present disclosure. Drying can be facilitated by gentle blowing with or without low heating of the air.

Since initial efforts to use silver nanowires for forming conductive coatings, effort has been devoted to decreasing the sheet resistance resulting from junction resistance between the nanowires. As demonstrated in Applicant's initial fusing work, simple deposition of nanowire dispersions to form a sparse metal layer can result in very high sheet resistance values, such as in the megaOhm/sq. range. See, for example, the '207 patent cited below. Various efforts have been used in that effort, such as application of pressure and use of various energy sources. A corresponding concern is the processability of the nanowire inks to form consistent good quality coatings. Applicant made an important leap in this effort through the invention of chemical fusing, which can be effective even if the unfused structure has a very high sheet resistance.

Ancillary to the fusing process, Applicant introduced process aids, especially binders, and coating agents, to provide for commercially processible and reproducible coating properties. To avail themselves of these process aids consistent with achieving fusing, Applicant discovered that binder selection was important. Hydrophilic binders were used with particular success found with polysaccharide binders. Due to widespread commercial use in many applications including similar applications, cellulose based binders were convenient polysaccharides to adopt. While not explicitly pointed out, Applicant's earlier work in the '968 patent, cited below, discovered considerable improvements in sheet resistance using polysaccharide binders without applying pressure or any further processing steps. While still not fully understood, the appropriate polymers are able to reduce junction resistance to roughly the degree as applying extremely high pressures, although chemical fusing still provides significant further reduction due to joining of the silver nanowires in forming an integral structure. While not wanting to be limited by theory, this observation strongly suggests some interactions between the polysaccharide binders and the metal nanowires allow for the nanowires to be appreciably close in proximity such that the nanowires can be electrically associated with one another and good conductivity can be achieved in networks of nanowires and polysaccharide binders provided the correct chemistries and processing are employed. Without wanting to be limited by theory, this evidence also suggests some driving force and beneficial assembly on the nanoscale between the polymer and the nanowires which tends to increase silver-silver contact while also providing significant surface association of the silver nanowires with the cellulose.

Also, the synthesis of silver nanowires generally involves the use of polyvinylpyrrolidone (PVP) as a capping agent that facilitates nanowire growth. Purification of the as synthesized nanowires generally removes excess PVP, but some PVP generally remains bound to the nanowires. Aggressive processing to remove PVP can result in undesirable silver nanowire agglomeration. The silver nanowire inks described herein carry forward some PVP. Additional polymer binders can be added to impart desired material properties to the ultimate product material, and such as hydrophilic polymer, e.g., cellulose-based polymer, or UV crosslinkable polymers and resins. Due to the higher density of metallic silver, relatively lower amounts of organics can still result in a moderately high volume fraction of organics. Generally, the purified silver nanowires retain from about 5 wt % to 20 wt % PVP relative to the silver nanowire weight. Since low amounts of added binder may be used, the PVP may be a dominant organic component. Preliminary results suggest that amounts of PVP can be reduced by further purification, although excess removal of PVP can result in agglomeration since PVP also functions as a dispersant, and moderate removal of PVP can be consistent with well dispersed inks and high electrical conductivity. Thus, dispersions can be formed with from 1 wt % to 20 wt % or in some embodiments from about 2 wt % to about 7 wt % of PVP relative to the silver nanowire weight. While the silver nanowire aspect ratio is significant for establishment of the high electrical conductivity, a fraction of the silver can be replaced with other silver particulate shapes, such as silver flakes, silver nanoparticles or the like. In particular in the dispersion, an equilibrium will be achieved between PVP bound the surface (“bound PVP) and that found dissolved in the solvent (“free PVP”).

Applicant's efforts on room temperature fusing have identified the curious result that different silver salts as fusing agents exhibit significantly different chemistry in the fusing process. In particular, fusing with silver fluoride markedly facilitates fusing relative to silver acetate, and presumably other silver salts, in comparable ink systems using the same nanowires, binders and solvents. Silver fluoride was used as one of several fusing agents tested in the '746 patent and provided comparable results as silver nitrate in the processing described in that patent. The results herein are in comparison with silver acetate fusing agent. Attempts at fusing without any heating with silver acetate did not provide desirable results, as shown in results in the Examples below. The results suggest that even though the anions are believed to be spectators in the relevant reactions, the anion identity may alter the free energies of the reactions, and/or may affect various activities, energetic barriers associated with diffusion and reduction, although Applicant does not want to be limited by theory. In any case, the results strongly suggest that these systems are poised near equilibrium to have controlled fusing, so relatively modest changes in free energy have observable effects. It is possible that other anions, or complexes would invoke similar performance as fluoride, but this is not clear. Other silver halides are insoluble in relevant solvents, and soluble silver salts generally have anions that would seem to be more similar to the acetate anion.

For the present highly conductive materials, the addition of a silver salt as a fusing agent seems to result in a slight decrease in electrical conductivity in some embodiments and a slight increase in electrical conductivity in other embodiments. It is not clear why this occurs. Initial results though suggest that fusing agents are not as advantageous for the highly conductive materials described herein compared with sparse metal layers. Fusing with metal salts is a tool available to potentially increase electrical conductivity somewhat and the mechanical properties of the material may be influenced as well. While not wanting to be limited by theory, as the contact points (junctions) increases between metallic particles, the total resistances decreases with the limiting case of infinite connections which would mathematically approach bulk metal resistances (for a system with junction resistance composted on infinite resistors in parallel R→as i→infinity since 1/Rₜₒₜₐₗ=Σᵢ^{∞}1/Ri). Since each metallic segment (i.e. not junctions) also have inherent resistances, once there are a sufficient number of low resistance junctions, the inter-segment and inter-particle resistances can become roughly on the same order of magnitude and fusing and or complete sintering into electrically and chemical bound structures need not be necessary to achieve very low resistances. While not wanted be limited by theory, for sparse networks, which can have higher optical transparencies, there are far few junctions and long inter-particle segments, compared to the opaque denser structures described herein and therefore the effects of the junction on dominating the overall resistances can be far more severe in sparse networks vs. dense ones.

For commercial silver nanowire inks for forming transparent conductive films, uniform coating on many substrates involves lowering the surface tension of the inks. It can be desirable to use higher silver nanowire concentrations for forming highly conductive materials, but the general knowledge relating to silver nanowire ink compositions can be carried over to forming these more concentrated inks for forming the highly conductive materials. Various surfactants can be used in principle, and fluoro surfactants have found popularity due to various pragmatic reasons. Alcohols can serve both as solvents and as wetting agent to form good coatings at higher concentration. With room temperature processing, high alcohol inks have been shown to be effective at forming highly conductive coatings with or without fusing. The alcohols can be chosen to have sufficiently low boiling points to evaporate relatively effectively at room temperature. Alcohol selection may correlate with the amount of alcohol used. While depending on the particular branching structure and placement of the hydroxyl group, boiling points tend to increase with molecular weight, so higher alcohols with more carbon atoms tend toward higher boiling points and correspondingly lower vapor pressure at room temperatures. Generally, alcohols of interest can be C1 to C10 (based on total numbers of carbon atoms in the molecules) alcohols at concentrations from 20 volume percent to 100 volume percent based on solvent liquids.

As described herein, it is possible to make thin highly electrically conductive coatings that are not transparent using room temperature processing as described herein. With respect to transparent conductive films, Applicant's development efforts have provided high quality transparent conductive layers with outstanding optical qualities comparable to the highest quality indium tin oxide in a material that is bendable and formable such that it can be stretched and repeatedly folded with endurance of the electrical conduction. On the other hand, higher levels of electrical conduction can be achieved with some sacrifice of the transparency. These coatings can be formed on materials that can be temperature sensitive substrates and can be flexible. For embodiments without the goal of good optical properties, lower quality silver nanowires can be used, which can tolerate larger proportions of non-nanowire nanoparticulates, such as blends of shapes, blended with nanowires.

Transparent materials are generally ascribed in the art as having an average transmittance of visible light of at least 60%, and this view is adopted herein. Thin transparent conductive coatings can achieve a sheet resistance of roughly less than about 3 Ohms/sq after room temperature processing. To achieve even lower sheet resistance values, the materials become translucent and ultimately opaque. Conversion of the sheet resistance to values of resistivity involves the thickness, as described further below.

Chemical sintering has been discussed in the context of non-transparent structures. Using roughly spherical silver nanoparticles, room temperature sintering was achieved in the context of either forming a pre-coating of a cationic chlorinated polymer (polydiallyldimethylammonium chloride, poly-DADMAC) or the subsequent deposition of a cationic chlorinated polymer. See, published U.S. patent application 2012/0168684 to Magdassi et al. (hereinafter the '684 application), entitled “Process for Sintering Nanoparticles at Low Temperatures,” incorporated herein by reference. Poly-DADMAC is a polyelectrolyte that would not be a desirable component in many contexts. In some embodiments, the '684 application described the inclusion of a sintering salt NaCl in the nanoparticle dispersion, but for these systems, they needed to heat the deposited material to achieve sintering.

The resulting structures taught by Magdassi are very different from the present materials. For the present materials, fusing with NanoGlue is not needed to produce good conductivity, although it may have some effect. The present results strongly evidence a transition to a conductive mass that seems to be correlated with the direct conduction along the nanowire structures combined with sufficient conductive band overlap due to the high loading of nanoparticulate silver. While not wanting to be limited by theory and to Applicant's knowledge, these electrical conduction properties have not been observed prior to this work. Similar ow temperature processing for silver pastes using silver flakes is described in U.S. Pat. No. 11,084,950 to Graddy Jr. et al., entitled “Fast Conductivity Polymer Silver,” incorporated herein by reference. The '950 patent does not report resistivities, but the materials in the '950 patent seem to exhibit resistivities several orders of magnitude higher than the present work.

While the '684 application mentions carboxymethyl cellulose, it does not teach appropriate use of polysaccharide binders, so they do not exemplify good conductivity without chemical sintering based on halide ions and chloride in particular. While Applicant has found particular desirable contributions of polysaccharide binders, such as cellulose, for transparent conductive films, in the highly conductive materials described herein, polymer binders seem interchangeable with respect to effects on conductivity of organic components being similar as long as they do not disrupt ink stability or cause nanowire agglomeration. Thus, polymer binders can be selected to influence mechanical properties of the dried conductive material. The use of silver nanowires seems to impart qualitatively different electrical conduction properties, which evidently is due to the morphology related to the high aspect ratio and potentially do the number density of connection points/junctions made between conductive particles

Silver can provide excellent electrical conductivity, and silver has the highest electrical conductivity of elemental metals. For forming non-transparent electrically conductive coatings, the characteristics of the metal nanoparticulates can become less significant, although the processing approaches herein are generally based on nanowire processing. The nanowire morphology seems to contribute significantly to the electrical conductivity even at high concentrations and high electrical conductivity. For forming thin conductive coatings that are non-transparent, high-quality nanowires may not be significant with respect to performance, so that the resulting cost can be significantly lower. At higher silver loadings, any nanoparticles and other non-wire shapes can contribute more to electrical conduction through forming conduction pathways at higher densities.

While fusing technology has not been found to have a large effect to date for the highly conductive materials that are the focus of the present work, a brief summary of this work is presented. With respect to Applicant's proprietary fusing technology, it was initially discovered that halide ions can drive the fusing of metal nanowires to form fused metal nanostructures. Fusing agents comprising halide anions were introduced in various ways to successfully achieve the fusing with a corresponding significant drop in the electrical resistance. It should be noted that halide ions in this processing context should not be confused with halide ions used in the nanowire synthesis reactions. Fusing of metal nanowires with halide sources is described further in U.S. Pat. No. 10,029,916 to Virkar et al., entitled “Metal Nanowire Networks and Transparent Conductive Material,” and U.S. Pat. No. 9,920,207 to Virkar et al. (the '207 patent), entitled “Metal Nanostructured Networks and Transparent Conductive Material,” both of which are incorporated herein by reference.

An extension of the process for forming fused metal nanowire networks was based on reduction/oxidation (redox) reactions that can be provided to result in fused nanowires without destroying the optical properties of the resulting coating. Metal for deposition at the junctions can be effectively added as a dissolved metal salt or can be dissolved from the metal nanowires themselves. The effective use of redox chemistry for fusing metal nanowires into a nanostructured network is described further in U.S. Pat. No. 10,020,807 to Virkar et al. (the '807 patent), entitled “Fused Metal Nanostructured Networks, Fusing Solutions with Reducing Agents and Methods for Forming Metal Networks,” incorporated herein by reference. Single solution approaches for the formation of fused metal nanostructured layers are described further in U.S. Pat. No. 9,183,968 B1 to Li et al, (hereinafter the '968 patent) entitled “Metal Nanowire Inks for the Formation of Transparent Conductive Films with Fused Networks,” incorporated herein by reference. The inks can further comprise dissolved metal salts as a metal source for the fusing process. Without wanting to be limited by theory, it is believed that components of the ink, e.g., hydroxyl groups, or other organic compositions, reduce the metal ions from solution to drive the fusing process—in particular as it relates to the reduction of silver from ions introduced into the inks. Previous experience with the fusing process in these systems suggests that the metal preferentially deposits at the junctions between adjacent metal nanowires, although the deposition mechanism in the present dense opaque or translucent systems is likely distinct. While not wanting be limited by theory, it is known that like materials can help catalyze reduction (i.e. a solid silver surface lowers the activation energy for reduction of a silver ion or complex) versus the “homogenous nucleation” case in the absence of a solid support. Cluster stability, and barriers to diffuse and disintegrate are also far more preferential in the presence of a solid substrate (i.e. metals surfaces). Finally, analogous to Applicants earliest work, its seems very plausible that areas of concavity/junction between particulates will be the thermodynamically and kinetically most favorable place for additional metal deposition and reduction. These junctions and intersection are also important contributors to the final resistivity of the structure.

A polymer binder can be provided to stabilize the coating and to influence ink properties. For the highly conductive materials, the polymer binder selection can be made to influence the properties of the final material, as long as the polymer binder precursors are compatible with the silver nanowire dispersion. The particular formulation of the ink can be adjusted to select ink properties suitable for a particular deposition approach and with specific coating properties on a substrate surface. Higher loading inks are found to exhibit non-Newtonian behavior. The non-Newtonian behavior can influence selection of deposition approach.

For a room temperature fusing process, the process conditions can be adjusted, optionally, with respect to blowing air at room temperature across the deposited coating. Slight heating can be used in some embodiments, if desired. Airflow with or without heating can speed solvent removal and corresponding concentration of the silver ions to provide for reasonable fusing rates. As long as the ion mobility is maintained and sufficiently reactive silver salts are utilized, solvent evaporation and drying (even at low temperatures) can result in fusing and excellent conductivities. In the context of lower temperature processing, the conductive inks described herein provide process advantages even relative to commercial alternatives. Referring to Table 1 below, the “Typical” product refers to silver nanoparticle pastes or inks that have been commercially available for some time an example is Toyobo 520H-19 or 520H-41 which cures at 130-150 C for 30 mins. The Low Temp 1 product refers to a next generation nanoparticle based product that is processable at somewhat lower temperatures. Examples of commercially available low temperature silver pastes include PE828 (“ULTRA-LOW TEMPERATURE CURE SILVER CONDUCTOR”) from DuPont™ which can be processed from 60-100 C.

TABLE 1

| | Resistance | | |
|---|---|---|---|
| | (mOhm/□/ | | |
| Ink Type | 25 μm) | Drying/Curing | Substrate Types |
| Typical | 12-15 | 120-150 C./30-60 | High T_{g}/Expensive |
| | | minutes | |
| Low Temp 1 | <25 | 60*-100 C./~1- | Lower T_{g} |
| | | multiple hours | PVC, PC, PS, PVDF, |
| | | | PE* |
| C3 Nano | <9 | <40 C./1-5 | PET, Acrylic, PC, TPU, |
| RT Ink | | minutes | PE, PS, PVDF |

The ability to form room temperature conductive coatings is both a desirable processing improvement as well as an opening to achieve processing substrates that are vulnerable to heat. The ability to allow polymer binder selection can allow for tuning of the properties of the conductive material to provide varying degrees of flexibility or rigidity, and may allow for UV curing. These materials can greatly expand performance parameters of previously developed conductive silver pastes and the like.

The concepts generated from nanowire based room temperature fusing processing has resulted in an even further advance in the formation of dense metal nanowires based structures with high metal loadings and very low electrical resistance without the use of fusing agents or high binder levels. Evidence suggests a new electrical conduction mechanism, which is not fully understood. In some embodiments, the metal density of the resulting conductive structures can be at least about 25% of the bulk metal density. The sheet resistance of the structures can be less than 5 Ohms/sq and in some embodiments less than 1 Ohm/sq, and the resistivity can be less than a factor of 20 times the resistivity of bulk silver. To impart more structural stability, a low level of crosslinkable polymer binder can be included to impart abrasion resistance and better adhesion.

A useful component of the formation of these highly conductive dense particulate structures involves the formation of concentrated aqueous dispersion or alcohol dispersion of metal nanowires with concentrations above about 3 wt % and in some embodiments above about 5 wt %. Also, the metal nanoparticles generally comprise at least about 75 wt % of the solids in the dispersion. The dispersions are stable for at least 24 hours with no settling observed with no agitation of the dispersions. These concentrated solutions can have a moderately high viscosity and exhibit shear thinning behavior so that such solutions may be more amendable to a wider range of deposition techniques. The low shear viscosities can be greater than 2500 cPs. The viscosity of the dispersions is surprisingly obtained by using less additives and not more additives to influence the properties so that the metal makes up a large fraction of the solids content. While a significant fraction of the metal content can be metal nanowires, some additional metal nanoparticle shapes can be used to form the dispersions and resulting conductive structures. Specific processing is used to achieve the highly concentrated dispersions in aqueous or other polar solvents. The ability to achieve very low electrical resistance opens the possibility of a wider range of desirable applications. A person of ordinary skill in the art will realize that additional ranges of metal density, resistance values, viscosity, dispersion concentrations and other values associated with the non-transparent highly conductive embodiments are contemplated and are within the present disclosure.

Processing to form the opaque, highly conductive nanoparticulate metal deposits can be processed at room temperature, which is desirable from an energy and process flow perspective. Solvent removal seems to result in the formation of the conductive structure. From that perspective, application of modest amounts of heat would not be expected to be detrimental to speed solvent removal. Since these structures and corresponding processing is believed to be reported for the first time, the disclosure herein is not intended to imply that low temperature processing, for example, no more than 60° C. is necessary since somewhat higher temperatures for limited periods of time should also be appropriate, even if the lower temperature processing has desirable aspects. For example, temperatures up to about 150° C. should be acceptable for short periods of time.

### Silver Nanowire Ink and Deposition

Silver nanowire inks for forming highly conductive materials can take on specific characteristics. To decrease the use of solvent and correspondingly solvent removal, more concentrated inks have been formed and are desirable if consistent with processing. As concentrations of nanowires increases, the rheology of the ink correspondingly changes. In contrast, for forming transparent conductive films with silver nanowire inks, the desirable processing has tended to favor balance (near balance of equilibria) and finesse rather than brute force to form fused metal nanostructured networks. To form non-transparent conductive structures, finesse is again effective, but in this limit fusing is not believed to be involved and an approach to form dense metal deposits is found to be successful to form a new material with high conductivity based on high metal density and resulting collective effects. Applicant's experience with formation of state of the art transparent conductive films provided experience on the importance of forming well dispersed silver nanowires at the start of processing. This experience has provided for the high concentration inks and highly conductive materials described herein. The formation of higher concentration inks involves forming a good dilute dispersion followed by concentrating by solvent removal to provide for well dispersed silver nanowires in the more concentrated dispersions. Aqueous dispersions can be formed up to about 20 wt % silver nanowires. Traditional approaches for forming higher concentration silver nanowire dispersions have relied on ultrasonication, which can damage the nanowires without being highly effective or using the dispersions without forming a good dispersion.

In some embodiments, the processing to form the desired highly conductive structures from the inks can be performed with silver nanowire inks at room temperature, although some heating can be used to speed solvent evaporation, so the processing can be even gentler while achieving good electrical conductivity. The inks thus involve appropriate selection of the components in the right amounts. First, there are the silver nanowires, and these are discussed in detail below, and the silver nanowires may be mixed with other silver nanoparticulates and/or silver flakes in minority amounts. The solvent is generally aqueous and can have alcohol in lower amount or larger amounts. Surfactants, such as fluoro-surfactants, may or may not be used, and the suitability of a surfactant may depend on the alcohol content of the solvent. A polymer binder can be used. In the new regime of low temperature processing of dense metal nanowire based structures for non-transparent low resistance structure, the inks have a high percent metal components as a fraction of the solids in the dispersion and relatively high metal concentration. Crosslinkable monomers, oligomers, or polymers with good mechanical strength can be added to the highly conductive structures to give them good mechanical stability.

The silver nanowires, with optional other silver particulates, can be selected as appropriate for the target application, and these can range over the spectrum from high quality very thin and uniform nanowire to mixtures of thicker nanowires with nanoparticles and other particulates. Applicant produces and sells a range of silver nanowire quality from very high-quality silver nanowires, which can be used to obtain very good optical qualities, to thicker and shorter silver nanowires that can be used at higher concentrations at a particular viscosity. Other silver particulates can be included to provide more conductive metal mass at a lower cost and with improved blending ability. For the highly conductive materials described herein, a majority of the mass of silver is in the form of silver nanowires since the silver nanowires seem to contribute in significant ways to the observed high electrical conductivity, which presumably is due to the conduction bands extending along the length of the nanowires.

Applicant has made great strides in understanding the properties of concentrated silver nanowire dispersions, their formation and uses thereof. The shape of metal nanowires is conducive to irreversible agglomeration, so processing of nanowire dispersions pays appropriate attention to avoiding the formation of agglomerates. The shape of metal nanowires also contributes to strong concentration dependence of the viscosity on the concentration. Higher aspect ratios tend to exasperate the rise of viscosity, so shorter and thicker nanowires may be desirable for forming opaque materials with nanowires. On the other hand, the high aspect ratio can contribute to good electrical conduction, and the results demonstrated herein seem to rely on the high aspect ratios of the nanowires. Similarly, other silver metal shapes, such as silver flakes and/or silver nanoparticles or other nanoparticulates, can add to the metal density without correspondingly influence the rheology at the same order of magnitude of an equivalent mass of nanowires.

Since the highly conductive materials described herein do not seem to benefit from chemical fusing using additional silver salts, polymer binders can be used besides the hydrophilic polymers generally used for transparent conductive films forming fused metal nanostructured network. Organic contributions to the inks provide a significantly lower density component relative to the silver. A significant fraction of the organics can be polyvinylpyrrolidone carried forward from the nanoparticle synthesis. Added polymer binder composition and quantity can be selected based on the desired composition of the ultimate composite material. The inks described herein comprise aqueous solvent, up to about 20 wt % silver particulates, with at least about 67 wt % silver nanowires, and from about 1 wt % to about 25 wt % non-volatile organics. Further details on ink formulations follow.

Opaque conductive layers can be formed from less purified dispersions of metal nanowires. Examples are presented below forming transparent or translucent coatings, but lower optical quality, electrically conductive films, that are formed with waste from synthesizing highly purified silver nanowires, in which the waste comprises ranges of nanowire morphology, nanoparticles and various other nanoparticulate shapes. This work points to the possibility of supplementing nanowires with nanoparticulates of other shapes for non-transparent applications. Commercial conductive products are generally based on silver flakes and/or silver nanoparticulates and microparticles. These other silver shapes do not contribute to longer range electrical conduction, but these other silver shapes can be dispersed with less of an effect on the viscosity of the dispersion. Electrically conductive pastes with silver flakes have been described with the capability of achieving low resistivities. See, for example, published U.S. patent application 2015/0262728 to Ogiwara et al., entitled “Electrically Conductive Paste Composition and Method of Forming an Electrical Circuit on a Polymer Substrate,” incorporated herein by reference. With greater than 90 wt % of the solids being silver flakes and with processing at 120° C. for 0.5 hrs, comparable results were obtained for some embodiments using silver flakes as were obtained herein.

The other metal, particulate, such as silver particulates, other than the silver nanowires, can have any reasonable shapes, although certain particulates are commercially available for use in loaded polymers, adhesives or resins. In particular, metal flakes and particles, roughly spherical, provide convenient availability for commercial scale production at a reasonable cost. Silver nanoparticles with roughly spherical shapes are commercially available in nanoscale sizes, average particle diameters no more than about 200 nm and with average particle diameters, as small as roughly 10 nm or less to as large as 200-300 nms. Micron sized roughly spherical particles are also available, with average particle diameters from about 1 micron to about 100 microns. A reasonable balance between performance and cost may be achievable with average particle diameters from about 100 nm to about 5 microns. Suitable suppliers of silver particles (micron-sized particles or nanoparticles) include, for example, Heraeus, Inframat Advanced Materials, Ames Goldsmith, Sigma Aldrich, SS Nano, Cerrion nano, SkySpring Nanomaterials, and Nanocomposix. Silver flakes can have a micron-scale lengths (or equivalent diameters) with a small thickness, such as average diameters from about 1 micron to about 20 microns and average thicknesses from about 100 nm to about 2 microns. A representative description of the synthesis of silver nanoflakes, see for example published U.S. patent application 2016/0114390 to Hori et al., entitled “Flake-Like Silver Powder, Conductive Paste, and Method for Producing Flake-Like Silver Powder,” incorporated herein by reference. Silver flakes are available commercially, for example, from Tanaka, Ferro, Reade, and Inframat Advanced Materials. In principle, any reasonable conductive particulates can be used, as well as blends thereof, such as silver coated particles, copper particulates, nickel particulates, and the like.

Silver provides excellent electrical conductivity. The present Applicant markets silver nanowire inks for forming fused metal nanostructured networks under the tradename ActiveGrid® ink. Applicant has recently developed a thicker line of silver nanowires suitable for opaque applications. For a description of the synthesis of these thicker silver nanowires, see copending U.S. provisional application 63/459,495 to Virkar et al., entitled “High Loadings of Silver Nanowires; Dispersions and Conductive Pastes; and Corresponding Methods,” incorporated herein by reference. Other silver nanowire sources are commercially available, and the basic fusing technology is well described in the '207 and '807 patents cited above. The vast majority (>98%) of silver nanowires in the Generation 5 (GEN5) ActiveGrid® product have diameters below <25 nm, and the vast majority (>98%) of silver nanowires in generation 7 (GEN7) ActiveGrid® silver nanowire diameter of <22 nm. The synthesis of thin silver nanowires is described in U.S. Pat. No. 10,714,230 B2 to Hu et al., entitled “Thin and Uniform Silver Nanowires, Methods of Synthesis and Transparent Conductive Films Formed from the Nanowires,” incorporated herein by reference. Herein, nanowires are considered to have average diameters less than 200 nm and in some embodiments less than 100 nm, average lengths of at least about 1 micron and in further embodiments at least about 2 microns, and average aspect ratios of at least about 10, in further embodiments at least about 50, in other embodiments at least about 75 and in some embodiments at least about 100. Various silver nanowires are commercially available from Applicant or other sources. Nanoparticulates can be identified by having at least one average dimension through the particle of no more than 200 nm, and in further embodiments no more than about 150 nm, in further embodiments, no more than about 100 nm, and in other embodiments no more than about 80 nm. Thus, nanoparticulates can include, for example, nanoplates, nanoparticles, nanoshells, nanorods and branched nanorods and the like. As noted above, microparticulates of silver can also be used. A person of ordinary skill in the art will recognize that additional ranges of silver nanowire and metal nanoparticulate dimensions within the explicit ranges above are conceived and are within the present disclosure.

The solvents for the inks may be aqueous (at least about 51 wt % and 51 vol % water), in some embodiments at east about 60 vol % water, in further embodiments at least about 75 vol % water, and in other embodiments at least about 95 vol % water. In some embodiments, the solvent is essentially just water. Other volatile components of the inks can comprise other liquids miscible in water or at least soluble at the relevant concentration ranges. Organic solvents can comprise alcohol, which can improve the rheology of the inks, or other polar solvents. If alcohol is used, the selection of alcohol is not generally critical, but the alcohol generally should have a low boiling point to allow for good drying at room temperature or with gentle heating. From this perspective, alcohols are generally monohydroxyl aliphatic alcohols with no more than 10 carbon atoms, with methanol, ethanol, propanol, isopropanol, mixtures thereof, and the like being convenient. Smaller amounts of higher boiling polar components, such as glycols, can be added to influence ink properties. In some embodiments, the solvent comprises from 0.1 volume percent (vol %) to about 49 vol % alcohol, in further embodiments from about 0.5 vol % to about 40 vol %, and in other embodiments from about 1 vol % to about 25 vol % alcohol. The process of high loading dispersion can comprise initial dispersion of the silver nanowires in alcohol to form a good dispersion of the silver nanowires, as described further below. A person of ordinary skill in the art will recognize that additional ranges of solvent concentrations within the explicit ranges above are contemplated and are in the present disclosure. The solvent may also comprise no more than about 5 vol % of other components, such as polar solvents, for example, dimethyl formamide, dimethyl acetamide, N-methyl pyrrolidone, methyl ethyl ketone, glycol ethers (such as ethylene glycol methyl ether and propylene glycol methyl ether), methyl isobutyl ketone, ethyl acetate, butyl acetate, ethyl lactate, PGMEA (2-methoxy-1-methylethylacetate), dimethyl carbonate, or mixtures thereof. While the solvent should be selected based on the ability to form a good dispersion of metal nanowires, the solvents should also be compatible with the other selected additives so that the additives are soluble in the solvent.

In appropriate solutions, the inks are stable prior to deposition of the ink and drying. The inks can comprise a reasonable amount of polymer binder that contributes to the formation of a stable conducting coating for further processing. In the ink, polymer binder precursors can comprise dissolved solid polymer, and/or liquid monomers, oligomers, or polymers for deposition. Following deposition, the polymer binder precursors can form the polymer binder by drying and/or through polymerization, crosslinking or both polymerization and crosslinking, which may or may not be based on the same chemical mechanism. To facilitate polymer binder formation, the inks can comprise crosslinking agents, free radical initiators, catalysts and the like, which generally are present in small amounts as additives. To form transparent conductive films, to obtain good fusing results with one ink systems, hydrophilic polymers have been found to be effective as binders, in particular, such as cellulose, chitosan, xanthan gum, or other polysaccharide based polymers. In some embodiments, a polysaccharide binder can have an average molecular weight of less than 10,000 g/mol. Suitable cellulose binders include, for example, ether celluloses, such as methyl cellulose, ethyl cellulose, ethyl methyl cellulose, hydroxyethyl cellulose, hydroxypropyl cellulose, hydroxyethyl methyl cellulose, hydroxypropyl methyl cellulose, carboxymethyl cellulose, mixtures thereof, and the like. Other (polar) resins and oligomers are also suitable. For the formation of highly conductive, dense metal structures, some polysaccharides can be desirable process aides and small amounts of crosslinkable mechanically strong polymer binders can be used to strengthen the structure without sacrificing conductivity. While for transparent conductive films, polysaccharides have demonstrated remarkable properties in the context of binders for silver nanowires, for the formation of high silver loading opaque materials, polysaccharides have not demonstrated similar advantages relative to other binders. Other binders, such as crosslinkable binders, can be used to provide desirable mechanical properties of the conductive materials. Other suitable binders include, for example, suitable waterborne resins, such as acrylates, epoxies, urethanes, and blends thereof. See, for example, Jiao et al., “Advances in Waterborne Acrylic Resins: Synthesis, Principles, Modification Strategies, and Their Applications,” ACS Omega 2021, 6, 2443-2449, incorporated herein by reference. Crosslinkable water soluble resins are available commercially, and three acrylate resins from Arkema Sartomer Americas are exemplified below. Polymer binders are discussed further below in the context of the processed material.

A single ink formulation provides for depositing a desired loading of metal as a coating on the substrate surface and simultaneously providing constituents in the ink that provide desired properties of the cured conductive material. For the formation of a highly conductive material, in addition to having a high proportion of metal conductors for the solids of the ink, the inks should also have a high concentration of metal particulates, which in some embodiments is at least about 3.0 wt %, in further embodiments at least about 3.5 wt % and in other embodiments at least about 4 wt %. The high concentration of metal nanowires and optionally other nanoparticulates in the ink can be accomplished by forming a good dispersion with a majority of a polar organic solvent with a boiling point no more than about 95° C., such as an alcohol, for example ethanol or isopropyl alcohol, and evaporating the solvent to yield the appropriately concentrated dispersion or ink, which may or may not be aqueous. A person of ordinary skill in the art will recognize that additional ranges of nanoparticulate concentrations and solvent boiling points within the explicit ranges above are contemplated and are within the present disclosure.

The formation of inks for depositing the highly conductive, high metal density materials follows from improvements in forming the metal nanowire dispersions involving lower amounts of polymer dispersants, yet having a stable dispersion that coat with good particle packing. To facilitate and reduce solvent evaporation issues, it is desirable to form a more concentrated solution, as noted above. To concentration the solution, a method of forming an ink comprises evaporating an organic solvent to achieve the desired concentration. In some embodiments, the organic solvent can have a boiling point of no more than about 95° C. to concentrate an aqueous dispersion of metal nanowires to form an ink having a concentration of metal nanowires of at least 3 weight percent, wherein the ink is stable against visible settling for at least 24 hours with no agitation

For embodiments of particular interest, the nanowires are silver nanowires, and for fused embodiments, the metal ion source is a dissolved silver salt although other metal salts can be used to deposit reduced metal. The ink can comprise silver ions in a concentration from about 0.005 mg/mL and about 50.0 mg/mL silver ions, in further embodiments from about 0.01 mg/mL and about 25.0 mg/mL and in other embodiments from about 0.05 mg/mL and about 10.0 mg/mL. A person of ordinary skill in the art will recognize that additional ranges of metal nanowire concentrations and metal ion concentrations within the explicit ranges above are contemplated and are within the present disclosure. The concentration of metal nanowires influences the loading of metal on the substrate surface as well as the physical properties of the ink.

Metal nanowires generally comprise silver. Applicant has formed transparent conductive films with good optical properties with noble metal coated silver nanowires. See, U.S. Pat. No. 9,530,534 to Hu et al., entitled “Transparent Conductive Film,” incorporated herein by reference. Generally, other metal nanowires would be expected to have similar properties. Gold nanowires, platinum nanowires, palladium nanowires, copper nanowires and other metal nanowires would be expected to exhibit similar performance. Due to the high electrical conductivity of silver, silver nanowires are highly preferred for highly conductive materials, but noble metal coatings can improve the nanowire durability without significant detrimental effects on the electrical conductivity.

With respect to the ink formulation, polymer binders and or organic resin and the solvents are generally selected consistently such that the polymer binder is soluble or dispersible in the solvent. Based on the examples, the binder can be considered to be divided into polysaccharide binder and other binders. If no distinction is made, a reference to binder can be interpreted as total binder. As noted above, non-volatile organics can comprise from about 0.1 wt % to about 25 wt % of the ink solids, in further embodiments from about 1 wt % to about 20 wt %, in other embodiments from about 2 wt % to about 15 wt % and in some embodiments from about 2.5 wt % to about 12.5 wt %, which involve the non-volatile ink components. The weight percent values can be converted to volume percent values based on the respective densities, and due to the relatively high density of silver relative to organics, the volume percent of the binder will be correspondingly significantly higher and can be the majority volume component. Generally, the organic volume percent can be from about 10 vol % to about 95 vol %, in further embodiments from about 15 vol % to about 90 vol % and in other embodiments from about 20 vol % to about 87.5 vol %. Correspondingly, the metal volume percent can be in some embodiments from about 5 vol % to about 90 vol %, in further embodiment from about 10 vol % to about 85 vol % and in other embodiments form about 12.5 vol % to about 80 vol %. The non-volatile organics generally comprise polymer binders, resins, cross-linkable monomers and oligomers, although a fraction of the non-volatile organics can be process aids, such as surfactants, crosslinking agents, or other suitable additives. As noted above, silver nanowire synthesis generally results in polyvinylpyrrolidone (PVP) being carried forward with the silver nanowires. While the PVP amounts can be reduced with further purification, conventional purification can result in 5 wt % to about 20 wt % PVP, with roughly 10 wt % being roughly expected. Thus, the inks can comprise no added polymer binder in addition to the PVP, or in some embodiments from about 1 wt % to about 95 wt % of the non-volatile organics, in further embodiments from about 10 wt % to about 90 wt % and in other embodiments from about 20 wt % to about 85 wt % of the nonvolatile organics. A person of ordinary skill in the art will recognize that additional ranges of organic concentrations within the explicit ranges above are contemplated and are within the present disclosure.

In some embodiments, the nanowire ink can optionally comprise a rheology modifying agent or combinations thereof. In particular, the ink can comprise a wetting agent or surfactant to lower the surface tension, and a wetting agent can be useful to improve coating properties. A wide range of surfactants, such as nonionic surfactants, cationic surfactant, anionic surfactants, zwitterionic surfactants, Gemini surfactants, are commercially available. Fluoro surfactants can provide desirable ink properties, but for some applications and final formulations may be undesirable. The purpose of the fluorosurfactant is to act as a wetting agent to provide lower surface tensions, good wetting and film formation on the substrate. The wetting agent generally is soluble in the solvent as used. In some embodiments, the nanowire ink can comprise from about 0.001 weight percent to about 1 weight percent wetting agent, in further embodiments from about 0.002 to about 0.75 weight percent and in other embodiments from about 0.003 to about 0.6 weight percent wetting agent. A person of ordinary skill in the art will recognize that additional ranges of binder, and wetting agent concentrations within the explicit ranges above are contemplated and are within the present disclosure. Effective wetting and processing can be provided by higher alcohol concentrations in the solvent, as described above. In some embodiments, with high alcohol concentrations, the presence of a separate surfactant is found to be inhibitory of room temperature processing, but in other low alcohol solvents, a separate surfactant is found to work fine. In general, other processing aids may or may not be used in various inks, such as thickeners, antioxidants, etc., and some of these may be inhibitory to the room temperature processing while others may be fine. A person of ordinary skill in the art can readily test this based on the teachings herein. Generally though, other additives would be no more than about 5 wt % of the solids, which are considered the non-volatile components.

Silver nanowires for commercial use in forming transparent conductive films are generally deposited by slot coating, and this can be performed in a roll-to-roll format. Coating and fusing can all be performed conveniently in this format. Applicant has generalized this processing for very thin polymer sheets with two sided conductive coatings as described in published U.S. patent application 2020/0245457 to Chen et al., entitled “Thin Flexible Structures With Surfaces With Transparent Conductive Films and Processes for Forming the Structures,” incorporated herein by reference. For non-flat surfaces, dip coating, spray coating and the like can be used. For non-transparent highly conductive structures, the structures may be deposited to form thicker deposits after drying to provide a lower circuit resistance once the structure is connected with appropriate bus bars or the like. The highly conductive structures formed with denser metal can also be useful as bus bars or the like.

In general, the same nanowire ink formulations for slot coating, ink-jetting, dispensing, printing, other jetting, screen-printing and can be used with these alternative coating processes, although specific embodiments may suggest modification. The higher viscosities and non-Newtonian shear thinning behavior of the denser inks are more amenable to a wider range of deposition processes. The conductive layers can be patterned with laser patterning, etchant pastes, or photolithography, although some applications may not involve patterning and if the ink can be printed, the desired patterning can be formed during deposition. Nanowire morphology complicates printing of nanowire inks for fine feature sizes, though several developments in new printing techniques are being developed for in academic and industrial laboratories to print NW based inks with higher resolution. A description of metal nanowire printing is found in U.S. Pat. No. 8,454,859 to Lowenthal et al., entitled “Metallic Nanofiber Ink, Substantially Transparent Conductor, and Fabrication Method,” incorporated herein by reference.

Loading levels of nanowires onto the substrate can be presented as milligrams of nanowires or metal particulates generally for a square meter of substrate and can be calculated based on the known deposition amounts and areas. For transparent applications, the nanowire networks can have a loading for transparent films from about 1 milligrams (mg)/m² to about 500 mg/m², in further embodiments from about 0.5 mg/m² to about 200 mg/m², and in other embodiments from about 1 mg/m² to about 150 mg/m², while for opaque films, the loadings can be greater than 1000 mg/m², greater than 10,000 mg/m², or even greater A person of ordinary skill in the art will recognize that additional ranges of thickness and loading within the explicit ranges above are contemplated and are within the present disclosure. For non-transparent applications, the metal loading is not particularly limited, but depending on the nanoparticulate characteristics, there will be a range of translucent metal loadings and then opaque films with even higher metal loadings. The use of more concentrated inks provides for forming denser metal deposits, which can provide for lower resistivity as well as lower circuit resistances for appropriate applications. Multiple coatings can be performed to increase the loading and to decrease the sheet resistance. The metal loading is effectively determined by the concentration of nanowires, or other silver particles, in the ink and the wet coating thickness.

For processing at room temperature, processing after coating the ink can be minimal. For consistency and to speed drying a little, unheated air can be gently delivered to remove the solvent vapor and speed drying. Whether or not blowing is used, for thin films, sufficient drying to achieve fusing or to achieve desired conductivity without a fusing agent can be achieved in minutes. Thicker coatings can correspondingly take longer to dry for pragmatic reasons. Compared with traditional coating processing times, these times are short so no effort has been devoted to pushing the time to even shorter amounts, but presumably this timing can be optimized if desired. Air knifes or the alike can also be employed to dry the solvent to provide the final conductive film.

While not needed for appropriate systems, some heat can be applied to facilitate processing. For example, the blown air can be heated, or the coated substrate can be placed in an oven or the like at a selected temperature. Generally, though it is advantageous to process without added heat, when possible, for cost saving and reduction of environmental footprint, as well as to open the processing to a broader range of applications. In particular, heat can be applied to facilitate and speed dry and/or to crosslink polymer binders. Drying temperatures are generally below 250° C., although higher temperature may be tolerated for short periods of time. In further embodiments, drying temperatures can be from about 40° C. to about 225° C., and in further embodiments from about 45° C. to about 200° C. In some embodiments, heating can take place for from about 5 seconds to about 90 minutes, in further embodiments from about 10 seconds to about 75 minutes and in other embodiments form about 20 seconds to about 65 minutes. Similarly, radiation, such as UV radiation can be used to crosslink suitable polymer binders, resins, monomers and oligomers, and the resin and photoinitiator selection can guide suitable irradiation processes. A person of ordinary skill in the art will recognize that additional ranges of temperatures and heating times within the explicit ranges above are contemplated and are within the present disclosure.

### Electrically Conductive Structure

The electrically conductive structure can be designed to fit a particular application. Since the range of conductive materials that can be formed using the processing described herein is large, the ranges of properties can correspondingly cover wide ranges targeting different applications. Therefore, the full range of properties can be considered, and the coatings can be grouped to help focus on ranges of potential target applications. While a lot of Applicant's prior efforts have focused on transparent conductive films, the present focus is on opaque materials, although thin applications of the material could be translucent. Reasonable groupings for optical properties can have translucent materials (conductive layer transmittance from slightly above 0 to about 70%), and opaque materials (zero transmittance).

As optical quality and high transmittance become less critical, blends of nanoparticulates become suitable. Thus, nanowires are not necessarily highly purified away from other particle shapes if optimal transparency is not an objective. Removal and purification of nanoparticles which are formed during synthesis can be a significant factor in cost. Nanoparticles and other odd silver particulate shapes can contribute disproportionally to scattering and reflection relative to their contributions to electrical conductivity, but as optical properties become of less relevance, so do the contraindications of the presence of non-nanowire shapes. Thus, opaque and translucent conductive films and other structures can be formed for lower cost than high quality nanowire coatings. Once the electrically conductive coatings become opaque, presumably the coatings are no longer sparse and the nanoparticulate shapes become less relevant although nanowires still contribute disproportionally to conductivity for their weight according to results obtained to date. In particular, the silver nanowire aspect ratio also contributes to electrical conductivity, so for the highly conductive materials described herein, a majority of the metal mass should be metal nanowires as described above.

For opaque structures, the processed coating can approach more of a uniform densified material. In principle, for an opaque structure, the thickness is not limited. In particular, for the structures formed with concentrated nanowire inks. For highly conductive opaque or slightly translucent structures formed from high concentration inks, the structures can have average thicknesses of at least about 50 nm and in some embodiments at least about 100 nm, in further embodiments at least about 500 nm and subrange within these ranges. The thickness can be estimated by the total loading of mass per unit area and calculating the density assuming that the structure is not porous and that the densities of the components sum in proportion to their contribution to the mass. The thicknesses may be influenced by the desired electrical resistance of the structure, which decreases in proportion to the thickness. The thickness can either be estimated by using a weighted average of densities, or can be directly measured for example by using a micrometer.

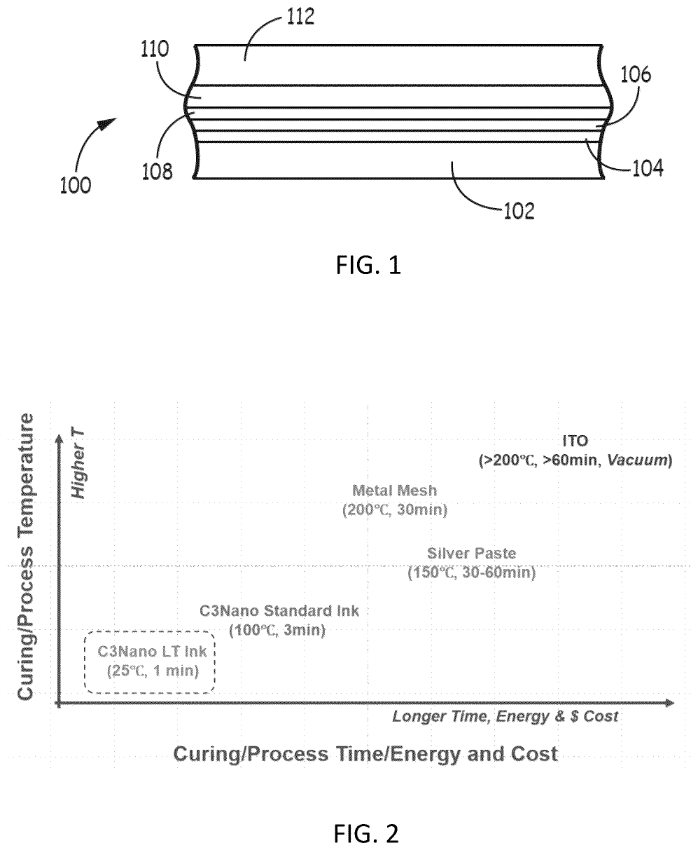

Referring to FIG. 1, representative electrically conductive film 100 comprises a substrate 102, optional undercoat layer 104, metal conductive layer 106, overcoat layer 108, adhesive layer 110 and protective surface layer 112, although not all embodiments include all layers. While polymer sheets are desirable substrates for many applications, for other substrates film 100 can be equivalently considered as an electrically conductive structure, so “film” as used herein can be equivalently considered as any reasonable structure. For transparent embodiments, metal conductive layer 106 would be sparse, substrate 102 would be transparent and adhesive layer would be optically clear, and other layers could be similarly made suitably transparent. Generally, adhesive layer 110 and protective surface layer 112 would be added after completion of significant processing described herein to improve stability of the conductive layer(s). A transparent conductive film generally comprises a sparse metal conductive layer and at least one layer on each side of the sparse metal conductive layer.

For some opaque embodiments, the total thickness of a metal nanowire based electrically conductive structure can generally have an average thickness from 0.25 microns to about 2 millimeters (mm), in further embodiments from about 1 micron to about 1 mm and in other embodiments from about 5 microns to about 0.5 mm, although generally any reasonable thickness can be used for opaque structures. It should also be noted that for non-transparent embodiments, the thickness is not generally limited, and the conductive structure can be placed directly on a structure to incorporate the conductivity feature, where in some embodiments the conductive structure can form a bus bar or similar conductive connection. A person of ordinary skill in the art will recognize that additional ranges of thicknesses within the explicit ranges above are contemplated and are within the present disclosure. In some embodiments based on conductive films, the length and width of the film as produced can be selected to be appropriate for a specific application so that the film can be directly introduced for further processing into a product. In additional or alternative embodiments, a width of the film can be selected for a specific application, while the length of the film can be long with the expectation that the film can be cut to a desired length for use. For example, the structures can be in long sheets or a placed on a roll. Similarly, in some embodiments, the film can be on a roll or in another large standard format and elements of the film can be cut according to a desired length and width for use.

For the range of potential applications, the substrate composition can be selected from a broad range of possibilities, especially for opaque embodiments. Examples are provided on cardboard and a fresh leaf, so even some porosity can be tolerated, although clearly extreme substrates may not be suitable. As noted above, for these broader applications, the structure can be considered as a film with no significance attributed to the film terminology. Thus, glass, ceramics, polymers, various organic and composite materials can be suitable substrates for opaque embodiments. In general, multiple polymeric and biological substrates require low processing temperatures due to melting, decomposition, unwanted reactions, or other adverse transitions and effects (glass transition, softening, diffusion, color loss, modulus changes). The ability to create a conductive layer at ambient temperatures or with low amounts of heating may therefore enable a host of new applications and commercial products. A conductive ink or composite pre-cursor can also be directly deposited onto an active component (for example a display, sensor, or alike) or as an interconnect to electrical or thermally connect other components, electronics or devices.

A substrate generally can have any reasonable dimensions. Roll-to-roll processing can be a convenient processing format for many commercial applications. Generally, for roll-to-roll embodiments, the substrate can have an average thickness from about 1 micron to about 1.5 mm, in further embodiments from about 5 microns to about 1 mm and in additional embodiments from about 10 microns to about 500 microns. In particular for foldable structures, especially double sided foldable structures, the substrate thickness can be no more than about 27 microns and in further embodiments from about 5 microns to about 25 microns. With appropriate selection of binder and processing, the highly conductive nanowire based materials should be appropriately flexible. A person of ordinary skill in the art will recognize that additional ranges of thicknesses of the substrate within the explicit ranges above are contemplated and are within the present disclosure.

Suitable polymers for a substrate include, for example, polyethylene terephthalate (PET), polyethylene naphthalate (PEN), polyacrylate, poly(methyl methacrylate), polyolefin, polyvinyl chloride, fluoropolymers, polyamide, polyimide, polysulfone, polysiloxane, polyetheretherketone, polyethersulfone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Suitable commercial polycarbonate substrates include, for example, MAKROFOL SR243 1-1 CG, commercially available from Bayer Material Science; TAP® Plastic, commercially available from TAP Plastics; and LEXAN™ 8010CDE, commercially available from SABIC Innovative Plastics. Polyimide substrates are available from Kolon, and polysulfone substrates are available from Solvay. Cyclic polyolefins (COP) are available from Zeon Corporation. The lowering of process temperatures as described herein allows for the use of even greater ranges of polymers as well as other substrates. For non-transparent substrates, most materials beyond polymers that can be reasonably coated can be used. The substrate or surface of deposition may also be a metal, glass, ceramic, and or specific component or device. Optionally, encapsulates, adhesive, barrier layers or other protective coatings can be added depending on the final reliability requirements and device design and architecture.

Substrate polymers may also be suitable as binder polymers. Binder polymers are generally hydrophilic. Thus, suitable binder polymers can include, for example, polyethylene terephthalate (PET), polyethylene naphthalate (PEN), polyacrylate, poly(methyl methacrylate), polyamide, polyimide, polysulfone, polysiloxane, polyester, epoxy, polyurethane, polyvinyl alcohol, polyvinyl acetate, copolymers thereof, or blends of these polymers. Corresponding inks can comprise dissolved polymers or polymer precursors or mixtures thereof referring to possible mixtures of polymers, mixtures of polymer precursors or mixtures of polymers and precursors. As noted above, the polymer binder can be provided in the inks as monomers, oligomers, dissolved polymers, or mixtures thereof that may be subsequently further polymerized or crosslinked.

If surface coating issues dominate, an undercoat can be applied to improve adhesion of a particular material. Also, potentially adhesion promoters and select resins can be added to improve adhesion. Thus, a thin polymer layer can provide a suitable surface for application of the conductive layer, although direct application of a conductive layer has been accomplished on a range of materials. Undercoat polymers can independently include classes of polymers described above for substrates and can be applied by solution coating with optional subsequent crosslinking, such as by UV light exposure or thermal curing. Undercoat polymers can be applied using the same techniques as the nanowire inks. Especially for less transparent or opaque embodiments, the thicknesses of these layers may not be significant, but for transparent embodiments and some other embodiments, the overcoat can have an average thickness from about 5 nm to about 2 microns, in further embodiments from about 7 nm to about 1 micron, and in other embodiments from about 8 nm to about 250 nm. A person of ordinary skill in the art will recognize that additional ranges of thicknesses within the explicit ranges above are contemplated and are within the present disclosure.

### Coating/Material Properties

The electrically conductive coatings or deposits from opaque materials can be formed for as non-transparent structures. Non-transparent, such as translucent or opaque, layers are generally formed with higher metal loading to impart lower sheet resistances. For these coatings, generally haze and other optical properties are not of particular concern. These highly conductive structures can be used to form metal traces, bus bars, electromagnetic shields, or the like.

Electrical resistance of thin coatings can be expressed as a sheet resistance (Rs), which is reported in units of ohms per square (Ω/□ or ohms/sq) to distinguish the values from bulk electrical resistance values according to parameters related to the measurement process. Sheet resistance along a surface can be generally measured using a four point probe measurement or another suitable process. If the thickness of the structure is known or measurable, the resistivity (p) can be evaluated as ρ=Rₛ·t, where t is the average thickness. The resistivity is an intrinsic parameter that it is independent of size and has units of ohms time length. For non-transparent coatings, sheet resistance values below 1 Ohm/sq can be achieved and translucent coatings can be formed roughly from this value or an order of magnitude larger. While not being limited by theory, it is believed that low resistances can be achieved by simply increasing the silver loading and/or by coating thicker, and low resistivities approaching that of bulk silver can be achieved by increasing the density. A person of ordinary skill in the art will understand this system can be modelled well using a parallel resistor model wherein the resistance can be estimated by the thickness. For example, if the conductive coating thickness is increased 2 fold from the thickness which achieved 1 ohm/sq, the thicker (2 fold) film should have a resistance of 0.5 ohms/sq. While the measured sheet resistance depends on the nature and dimensions of the corresponding structure, resistivity is an intrinsic property of a material independent of the structure, assuming that the material is uniform. Bulk silver resistivity is reported as 1.59×10⁻⁶ Ohm-cm, which is the lower limit for resistivities of a silver based conductor. The highly loaded silver materials can achieve resistivities no more than about 5×10⁻³ Ohm-cm, in some embodiments no more than about 5×10⁻⁴ Ohm-cm, in further embodiments, no more than about 1×10⁻⁴ Ohm-cm and in other embodiments from about 5×10⁻⁵ to about 5×10⁻⁶ Ohm-cm. In general, fusing with reduced silver salts does not seem to low the resistivity for these low binder embodiments. Therefore, with low temperature processing, it follows that the silver nanowires and any other nanoparticulates remain independent particulates within the composite in contrast to a fused metal nanostructured network. A person of ordinary skill in the art will recognize that additional ranges of sheet resistance within the explicit ranges above are contemplated and are within the present disclosure.

In principle, optical transparency is inversely related to the loading with higher loadings leading to a reduction in transparency, although processing of the network can also significantly affect the transparency. Also, polymer binders and other additives can be selected to influence optical transparency. The optical transparency can be evaluated relative to the transmitted light through the substrate. With the high loading inks described herein, formation of thin coatings can be useful to form translucent conductive films. For example, the transparency of the conductive film described herein can be measured by using a UV-Visible spectrophotometer and measuring the total transmission through the conductive film and support substrate. Transmittance is the ratio of the transmitted light intensity (I) to the incident light intensity (Iₒ). The transmittance through the coating (T_{coating}) can be estimated by dividing the total transmittance (T) measured by the transmittance through the support substrate (T_{sub}). (T=I/Iₒ and T/T_{sub}=(I/Iₒ)/(I_{sub}/Iₒ)=I/I_{sub}=T_{coating}). Thus, the reported total transmissions can be corrected to remove the transmission through the substrate to obtain transmissions of the coating alone. Transmission can be reported as total transmittance from 400 nm to 700 nm wavelength of light. In general, for metal nanowire based films, the measurements of 550 nm transmittance and total transmittance from 400 nm to 700 nm (or just “total transmittance” for convenience) are not qualitatively different. Transparency of the films on a transparent polymer substrate can be evaluated using the standard ASTM D1003 (“Standard Test Method for Haze and Luminous Transmittance of Transparent Plastics”), incorporated herein by reference. In general, the material and film properties can be adjusted to yield a selected transmittance form 0 to 70% for a translucent film.

### EXAMPLES

### General Materials and Methods

Inks S1-S7 were prepared based on ActiveGrid® Inks from Applicant C3Nano, Inc. as shown in Table 2. The ActiveGrid® Inks include GEN5 ActiveGrid® Ink with silver nanowires <25 nm in average diameter, GEN7 ActiveGrid® Ink with silver nanowires about 18 nm in average diameter, and GEN8 ActiveGrid® Ink with silver nanowires of average diameter of 13-15 nm. The inks included a hydroxyalkyl alkyl cellulose binder. Some of the ink formulations included silver salt AgOAc or AgF, and different levels of each silver salt were employed as detailed below for each example. The standard levels (1×) of AgF in GEN7 (1×_{G7}) and GEN8 (1×_{G8}) inks are about 50% greater than that of GEN5 inks. The silver salts were used in inks for the examples and are referred to as NanoGlue® AgOAc and NanoGlue® AgF.

TABLE 2

| | | NanoGlue ® |
|---|---|---|
| Ink | AgNW | Fusing Agent |
| S1 | GEN5 | AgOAc |
| S2 | GEN5 | AgF |
| S3 | GEN7 | AgOAc |
| S4 | GEN7 | AgF |
| S5 | GEN8 | AgF |
| S6 | GEN5 | none |
| S7 | GEN7 | none |

The inks were coated on various polymer substrates as shown in Table 3. Substrates included 50 μm PET (polyethylene terephthalate) with and without a hard coat layer, and COP (cyclic olefin polymer). The inks were coated with a slot coater set at different gap thicknesses of 1.5 mil (38.1 μm) or 4.0 mil (101.6 μm). For some samples, the inks were coated with a wire wound rod #14 to provide a gap thickness of 1.4 mil (35.6 μm).

TABLE 3

| | Average | Average |
|---|---|---|
| Substrate | % TT | % H |
| 50 μm PU | 94.0 | 0.87 |
| 50 μm primed PET | 93.6 | 0.58 |
| 50 μm hardcoated PET | 93.7 | 0.53 |
| 50 μm COP | 93.6 | 0.07 |

The samples were subjected to various processing conditions as detailed below for each example. Some of the wet coatings were initially dried with an air gun (with room temperature ˜25° C. air) approximately 1.5-3 inches above the film for about 30-60 seconds, and some were further heated in an oven heated at different temperatures ranging from 35° C. to 120° C. and different times ranging from 0.5 minutes to 210 minutes. Some of the wet coatings were dried at room temperature without any heating. Some of the wet coatings were dried at room temperature conditions with a fan blowing cool air at about 21° C. over the samples.

Average sheet resistance was measured using a sheet resistance measurement device from SURAGUS GmbH. Average percent total transmission (% TT) and average percent haze (% H) were measured using a haze meter. Average b* was measured using a colorimeter.

In general, processing to form the transparent conductive film was essentially as described in Example 5 of the '968 patent, cited above, with silver nanowires synthesized as described in U.S. Pat. No. 10,714,230B2 to Hu et al., entitled “Thin and Uniform Silver Nanowires, Methods of Synthesis and Transparent Conductive Films Formed From the Nanowires,” incorporated herein by reference.

### Example 1—Processing with or without Heat with Different Fusing Agents—Transparent Samples

This example demonstrates the performance of silver nanowire films with different silver salts dried and/or processed under different conditions as described below in Tables 4 and 5. Coatings were prepared on primed PET with 1.5 mil gap thickness.

TABLE 4

| | | | | Average |
|---|---|---|---|---|
| Ink S1 | | Oven | | Sheet |
| Sample | Drying | Temperature | Oven Time | Resistance |
| No. | Conditions | (° C.) | (min) | (Ohms/sq) |
| 1 | heat gun | — | — | 57 |
| 2 | heat gun | 120 | 2 | 37 |
| 3 | heat gun | 50 | 2 | 49 |
| 4 | heat gun | 50 | 5 | 47 |
| 5 | heat gun | 50 | 20 | 49 |
| 6 | heat gun | 50 | 60 | 45 |
| 7 | heat gun | 50 | 90 | 43 |
| 8 | heat gun | 50 | 120 | 42 |
| 9 | heat gun | 50 | 210 | 43 |
| 10 | no heating or | — | — | 64 |
| | oven drying | | | |

TABLE 5

| | | | | Average |
|---|---|---|---|---|
| Ink S2 | | Oven | | Sheet |
| Sample | Drying | Temperature | Oven Time | Resistance |
| No. | Conditions | (° C.) | (min) | (Ohms/sq) |
| 1 | heat gun | 120 | 2 | 35 |
| 2 | heat gun | 50 | 2 | 35 |
| 3 | heat gun | 50 | 2 | 33 |
| 4 | heat gun | 50 | 1 | 33 |
| 5 | heat gun | 50 | 0.5 | 33 |
| 6 | heat gun | 40 | 2 | 34 |
| 7 | heat gun | 40 | 1 | 33 |
| 8 | heat gun | 35 | 1 | 33 |
| 9 | heat gun | — | — | 32 |
| 12 | no heating or | — | — | 32 |
| | oven drying | | | |
| 11 | no heating or | — | — | 31 |
| | oven drying | | | |

As shown in Table 4, sample 2 dried in the oven at 120° C. for 2 minutes exhibited the lowest sheet resistance of 37 Ohms/sq. Samples 3-5, dried in the oven at 50° C. for 90 to 210 minutes, exhibited similar sheet resistances of 42-43 Ohms/sq such that the sheet resistance did not significantly decrease after 90 minutes, at least up to 210 minutes. Sample 6, dried in the oven at 50° C. for 60 minutes, exhibited a sheet resistance of 45 Ohms/sq. Thus, for samples 3-9 dried at 5000, sheet resistance decreased as drying time increased, with sheet resistance approaching the lowest value obtained for sample 2 dried at 12000. Even after 210 minutes, samples dried at 50° C. presumably did not fuse to the same extent as sample 2 dried at 12000. Samples 1 and 10, dried without heating in the oven, exhibited the highest sheet resistances as compared to samples that were dried using heat. Sample 1 dried with the heat gun and not placed in the oven had a sheet resistance of 57 Ohms/sq and the sample that was not dried with the heat gun or placed in the oven had a sheet resistance of 64 Ohms/sq.

As shown in Table 5, samples 9-11 were not dried in the oven and exhibited the lowest sheet resistances of 31-32 Ohms/sq. Sample 9 was dried using only the heat gun, and Samples 10 and 11 were dried without heat. Samples 2-5, dried at 50° C. from 0.5 to 2 minutes, exhibited similar sheet resistances of 33-35 Ohms/sq, with samples 2 and 3 being repeat samples. Samples 6-8, dried at 35-40° C. for 1 to 2 minutes, exhibited about the same sheet resistances regardless of temperature or time, and which were similar to sheet resistances obtained at 50° C. Sample 1, dried with the heat gun and in the oven at 120° C., exhibited a sheet resistance of 35 Ohms/sq which may be comparable or higher than that exhibited by samples 2 and 3 dried at 50° C.

The data shown in Tables 4 and 5 exemplify differences in sheet resistances obtained with AgF versus AgOAc as fusing agents. Sheet resistances for S2 fused with AgF were approximately independent of processing conditions, which was not the case for S1 fused with AgOAc. Sheet resistances for S2 were approximately the same regardless of temperatures ranging from room temperature to 120° C., at least over the times ranging between 1 and 2 minutes, however, the data suggest that processing without heat provides a more desirable result regarding sheet resistance, as compared to drying at temperatures as low as 35° C. Processing conditions of samples including AgF provide a more desirable result regarding sheet resistance, as compared to drying under any of the conditions investigated when AgOAc was used.

### Example 2—Processing of Inks with Smaller Diameter Silver Nanowires, with AgF

This example demonstrates the performance of a silver nanowire ink including silver nanowires having smaller diameters than those included in the S1 and S2 inks of Example 1. GEN7 ActiveGrid™ Ink, with AgF at a 1×_{G7} level was coated at different thicknesses and subjected to different processing conditions, although the base amount (1×) is somewhat higher concentration for the thinner nanowires.

Ink S4 with AgF at a 1× level were coated at 1.5 mil or 4.0 mil gap thicknesses on COP, and samples for each of the thicknesses were processed as described in Table 10. An S4 ink with a higher level of Ag (labelled Ag-1X) and the same 1× level of AgF was also prepared and coated at 4.0 mil thickness and processed with cool air. Results are shown in Table 10. Transmittance in Table 6 is reported for both the overall structure and parenthetically for just the transparent conductive film (TCF).

TABLE 6

| | | | Average | Average | |
|---|---|---|---|---|---|
| S4 | Blade | | Sheet | % TT | |
| AgF | Thickness | Processing | Resistance | (% TT | Average |
| Level | (mil) | Conditions | (Ohms/sq) | TCF) | % H |
| 1x | 1.5 | cool fan | 32 | 92.1 (98.4) | 0.62 |
| 1x | 1.5 | 2 min at 120° | 34 | 91.9 (98.2) | 0.76 |
| 1x | 4.0 | C. cool fan | 9 | 89.1 (95.2) | 1.76 |
| 1x | 4.0 | 2 min at 120° | 11 | 87.9 (93.9) | 2.13 |
| Ag-1x | 4.0 | C. cool fan | 3 | 78.6 (84.0) | 4.78 |

For samples prepared from ink S4 with a 1× level of AgF, the data in Table 6 show that for either thickness, little or no change in surface resistance or % TT is exhibited with differences in processing conditions. The samples coated at the 4.0 mil thickness exhibited lower sheet resistance by about 23 Ohms/sq and a decrease in % TT of about 3-4%, as compared to the samples coated at 1.5 mil. The data with respect to sheet resistance and % TT are comparable to that obtained for S2 inks prepared with GEN5 inks, although sheet resistance is somewhat less. Again, these results indicate that roughly full fusing seems to occur without application of any heat (cool fan). These results indicate that a transparent coating (>70% TT) can be formed at a 3 Ohm/sq. sheet resistance.

Values for % H increase by about 0.1% at the 1.5 mil thickness, and by about 0.37% at the 4.0 mil thickness, depending on processing conditions. At 1.5 mil thickness, both samples exhibited % H of 0.6-0.8%. At 4.0 mil thickness, effects of processing conditions were more pronounced with the sample processed with cool air exhibiting % H of 1.76%, and the sample processed for 2 min at 120° C. exhibiting % H of 2.13%.

### Example 3—Optical and Conductivity Performance of Inks Processed Under Ambient Conditions

This example further demonstrates optical performance and conductivity of ink coatings processed at ambient conditions.

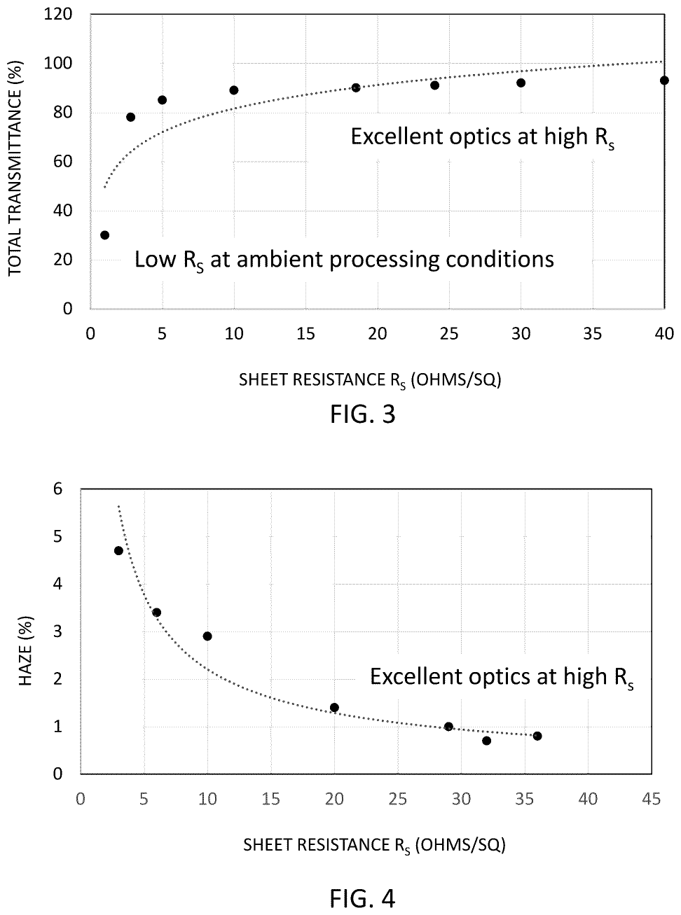

Inks of varied AgNW loadings were coated at different (4.0, 3.0, and 1.5 mil) gap thicknesses on COP to achieve a wide range of sheet resistances, and the samples were processed for about 1 min at ambient conditions. Selected performance data are shown in Table 14. Transmittance in Table 14 is reported for both the overall structure and parenthetically for just the transparent conductive film (TCF). Plots of sheet resistance versus % TT and % H are shown in FIGS. 3 and 4, respectively.

TABLE 7

| | Average | | | Avg. | |
|---|---|---|---|---|---|
| | Sheet | | Sheet | % TT | |
| | Resistance | Resistivity | Resistance/mil | (% TT | Avg. |
| Ink | (Ohms/sq)¹ | (Ohms-cm) | ((Ohms/sq)/mil)² | TCF) | % H |
| S5-H | 3 | 2.1 × 10⁻⁵ | 8.2 × 10⁻³ | >75 (>80) | <4.80 |
| S5 | 10 | 6.9 × 10⁻⁵ | 2.7 × 10⁻² | >85 (>91) | <3.00 |
| S5 | 40 | 9.6 × 10⁻⁵ | 3.8 × 10⁻² | >92 (>98) | <0.55 |

¹Dried 1 minute, ambient conditions; on COP
²Estimate

The results indicate excellent optical properties in combination with desirable conductivity properties can be obtained for ink coatings dried at ambient conditions.

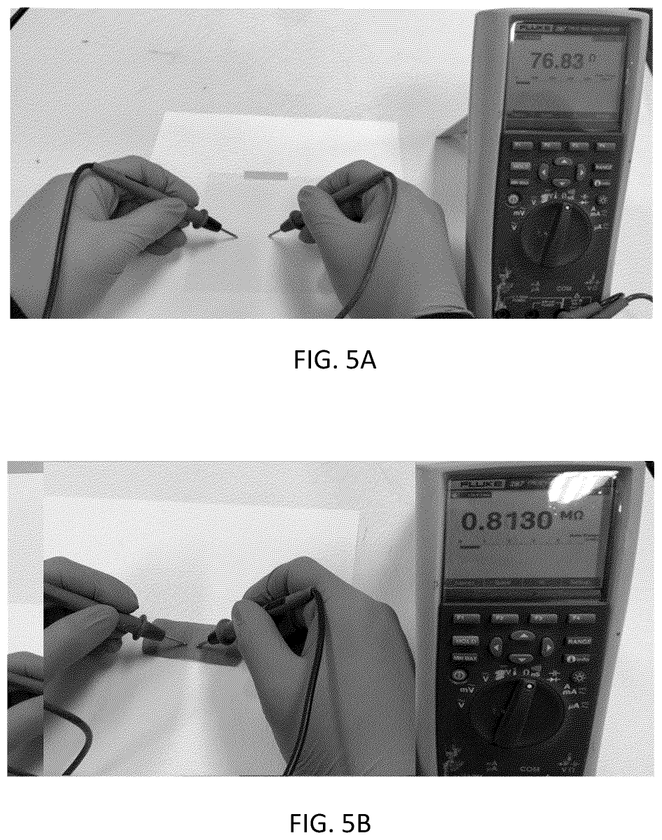

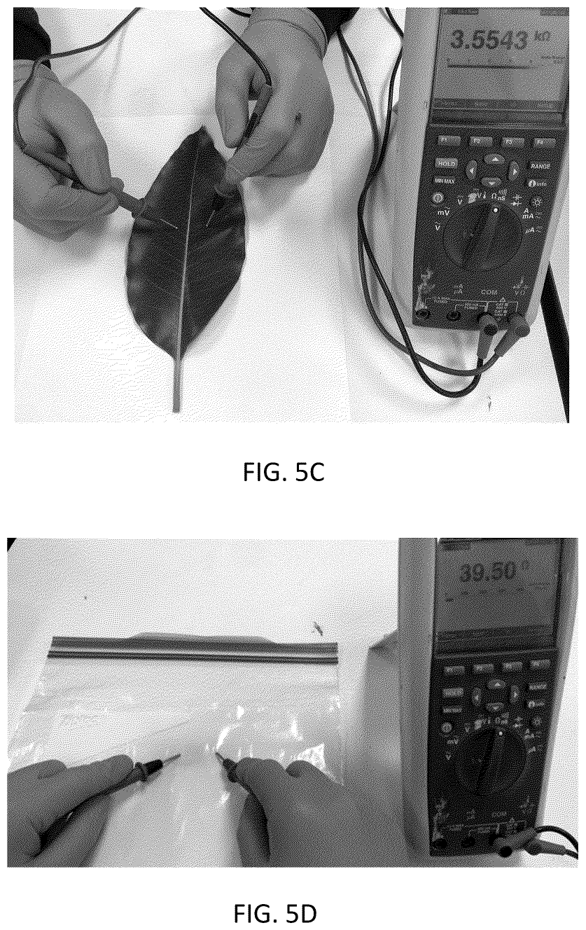

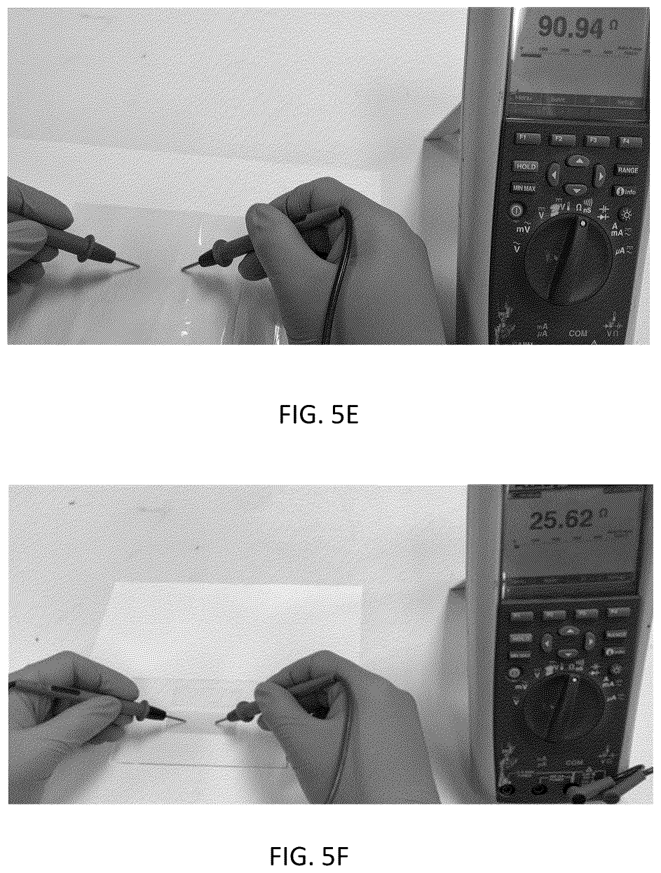

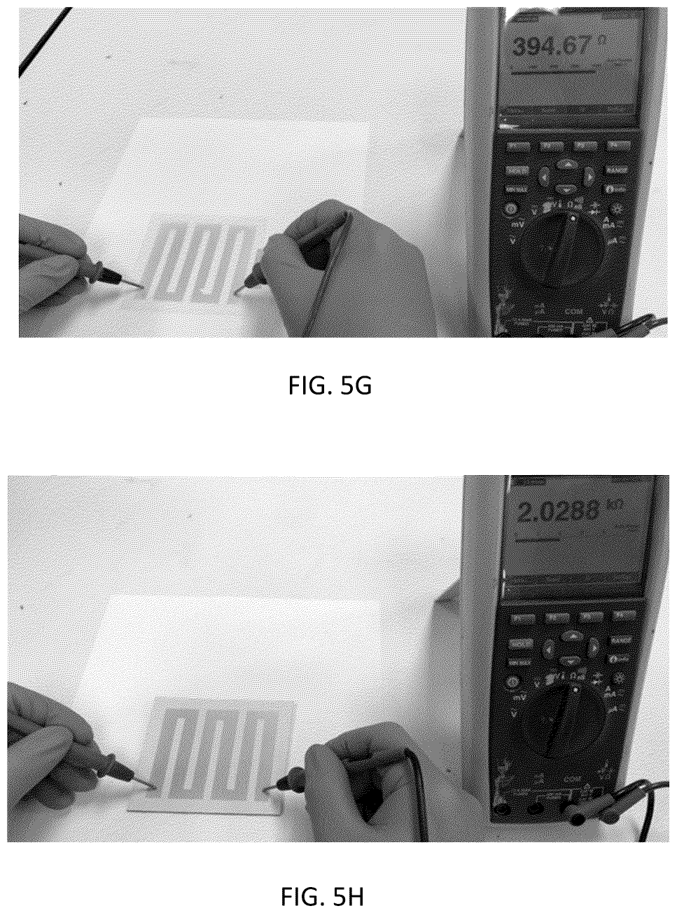

An ink comprising GEN5 nanowires and AgF was formed as a coating or a circuit on various substrates, including heat sensitive substrates, and dried under ambient conditions. The substrates included medical grade polyurethane, a medical bandage, a leaf, a Ziploc® bag, shrink wrap, Scotch™ Tape (coating on adhesive layer of the tape), PET and packaging cardboard. Resistance was measured by direct contact measurement as shown in FIGS. 5A-5H. While crude resistance measurements were attempted, obtaining accurate measurements for many of these substrates was not attempted and the nature of the substrate resulted in uncertainty.

### Example 4—Performance of By-Product Silver Nanoparticulate Ink—Transparent or Translucent Conductive Films

This example demonstrates performance of inks prepared from silver by-products resulting from the synthesis of silver nanowires.

The by-product silver nanoparticulates mixture was recovered from the centrifugal residue of the purification process for production of GEN 5 silver nanowires.

Three samples were characterized using titration and thermogravimetric analyses (745° C.) and results are summarized in Table 8.

TABLE 8

| | Ag¹ | Ag² |
|---|---|---|
| By-Product | (%) | (%) |
| W1 | 0.97 | 1.17 |
| W2 | 0.98 | 1.06 |
| W3 | 0.707 | 5.61 |

¹Titration
²Thermogravimetric analysis

Ink S17 was formulated using the by-product W1 at 4× Ag loading and 1× cellulose binder, with AgF as fusing agent. Ink S18 was formulated with the same ratio of all components except that concentrations of all solids are approximately 60% higher than in Ink S17. The ink was coated and dried to prepare coatings as shown in Table 9 and results are included.

TABLE 9

| | Coating | | Sheet | | |
|---|---|---|---|---|---|
| | Thickness | Drying | Resistance | | |
| Ink | (mil) | Conditions | (Ohms/sq) | % T | % H |
| S17 | 1.5 | room | 20-30 | 83.5 | 13.5 |
| | | temperature | | | |
| S17 | 1.5 | 5 min, 120° C. | 20-25 | 84 | 5.5 |
| S17 | 2 | 5 min, 120° C. | 10-15 | 79 | 8.5 |
| S18 | 2 | 5 min, 120° C. | 4-6 | 67 | 12.5 |

Ink S19 was formulated using the by-product W2 (W1 filtered through a 400 mesh filter) at 4× Ag loading and 1× cellulose binder, with AgF as fusing agent. Ink S20 was formulated the same as ink S19 except no fusing agent was added. The inks were coated and dried to prepare coatings as shown in Table 10 and results are included.

TABLE 10

| | Coating | | Sheet | | |
|---|---|---|---|---|---|
| | Thickness | Drying | Resistance | | |
| Ink | (mil) | Conditions | (Ohms/sq) | % T | % H |
| S19 | 1.5 | room | 16-18 | 82.5 | 5.8 |
| | | temperature | | | |
| S19 | 1.5 | 5 min, 120° C. | 16-18 | 84.5 | 5.3 |
| S20 | 1.5 | room | 45 | 83.5 | 5.6 |
| | | temperature | | | |
| S20 | 1.5 | 5 min, 120° C. | 28-32 | 85.5 | 4.8 |

Ink S21 was formulated using the by-product W3 (W1 further concentrated by an aggregation step) at 4× Ag loading and 1× cellulose binder, with AgF as fusing agent. The ink was coated and dried to prepare coatings as shown in Table 11 and results are included.

TABLE 11

| | Coating | | Sheet | | |
|---|---|---|---|---|---|
| | Thickness | Drying | Resistance | | |
| Ink | (mil) | Conditions | (Ohms/sq) | % T | % H |
| S21 | 1.5 | 5 min, 120° C. | 15-18 | 86.0 | 3.7 |
| S21 | 1.5 | room | 18-19 | 86.0 | 3.5-4.0 |
| | | temperature | | | |

### Examples 5-10—Opaque Conductive Materials

The following materials were used in Examples 5-10.
HPMC10K, (hydroxypropyl)methyl cellulose, average Mn 10K
Hypromellose (hydroxypropyl) methylcellulose
MC311, Methocell™ 311
SR415, ethoxylated (20) trimethylolpropane triacrylate
SR740A, polyethylene glycol 1000 dimethacrylate
SR9038, ethoxylated (30) bisphenol A diacrylate

### Example 5—High AgNW Loading with Reduced (HPMC) Binder Level

This example was carried out to compare performance of films formed from inks having different concentrations of silver nanowires and binder.

Inks 1-a through 1-d were prepared with formulations as shown in Table 12. As with the earlier Examples, the NanoGlue® (NG) was AgF, and the concentrations were as noted above.

TABLE 12

| | AgNW | | Binder | EtOH | |
|---|---|---|---|---|---|
| Ink | (wt %) | Binder | (wt %) | (wt %) | NG |
| 1-a | 2.03 | MC311 | 0.015 | 87.0 | 10x |
| 1-b | 0.09 | MC311 | 0.150 | 69.0 | 1x |
| 1-c | 2.03 | MC311 | 0.015 | 87.0 | 0 |
| 1-d | 0.09 | MC311 | 0.150 | 70.0 | 0 |

Coatings with Inks 1-a through 1-d were prepared by blade coating the inks onto PET having a hardcoat on one side and a thickness of 125 micron (PET-HC). Each ink was coated at two different slot-die gap thicknesses of 1.5 mil and 6.0 mil. For each thickness, two coatings were prepared and drying was carried out either at room temperature or at 120° C., for up to 2 minutes. For each coating, sheet resistance was measured and resistivity was calculated. The resistivity was calculated based on thicknesses measured by estimating the dry thickness from the given solid loadings and wet coating thickness. Results are shown in Tables 13 and 14.

TABLE 13

| | Sheet Resistance, Rₛ | | | |
|---|---|---|---|---|
| Coating | (Ohms/sq) | | | |
| on HC-PET | Room Temperature Drying | | 120° C. Drying | |
| (125 micron) | 1-2 minutes | | 2 minutes | |
| Ink | 1.5 mil blade | 6.0 mil blade | 1.5 mil blade | 6.0 mil blade |
| 1-a | 2.03 | 0.353 | 2.29 | 0.381 |
| 1-b | 47.5 | | 51.1 | |
| 1-c | 1.96 | 0.401 | 1.95 | 0.391 |
| 1-d | 57.5 | | 53.2 | |

TABLE 14

| | Resistivity ρ, calculated | | | |
|---|---|---|---|---|
| Coating | (Ohm-cm) | | | |
| on HC-PET | Room Temperature Drying | | 120° C. Drying | |
| (125 micron) | 1-2 minutes | | 2 minutes | |
| Ink | 1.5 mil blade | 6.0 mil blade | 1.5 mil blade | 6.0 mil blade |
| 1-a | 0.0000163 | 0.0000113 | 0.0000183 | 0.0000122 |
| 1-b | 0.000115 | | 0.000123 | |
| 1-c | 0.0000152 | 0.0000129 | 0.0000152 | 0.0000125 |
| 1-d | 0.000138 | | 0.000127 | |

The data suggest the following:
Lower resistivity with low level of binder relative to Ag
Particular nanoglue (AgF at 10×) did not show positive effect with the high alcohol formulation when AgNW loading is high.
NanoGlue® in “standard” more dilute ink formulation showed improvement of conductivity with RT drying (1-b vs. 1-d)

### Example 6—High AgNW Loading with Various Binders at Reduced Levels

This example was carried out to compare performance of films formed from inks having different binders.

Inks 2-1 through 2-V were prepared with formulations as shown in Table 15.

TABLE 15

| | AgNW | | Binder | EtOH | |
|---|---|---|---|---|---|
| Ink | (wt %) | Binder | (wt %) | (wt %) | NG |
| 2-I | 2.03 | MC311 | 0.015 | 86.6 | 3x |
| 2-II | 2.03 | Hypromellose | 0.015 | 86.6 | 0 |
| 2-III | 2.03 | HPMC10K | 0.015 | 86.6 | 0 |
| 2-IV | 2.03 | SR9038 | 0.015 | 86.6 | 0 |
| 2-V | 2.03 | SR9038 | 0.015 | 86.6 | 3x |

Coatings with Inks 2-1 through 2-V were prepared by blade coating the inks onto PET-HC using a gap thickness of 1.5 mil. Each coating was prepared twice and drying was carried out either at room temperature or at 120° C. for up to 2 minutes. For each sample, sheet resistance was measured, and resistivity was calculated. Measurements to determine total transmittance, haze and b* were also carried out for each sample. For samples dried at 120° C., an adhesion test was carried out for samples before and after application of UV radiation at 1.8 J/cm². The adhesion test included adhering Scotch® Light Duty Packaging Tape 610 from 3M Co. to the coated side of the sample, and after 60 seconds, removing the tape by grasping the free end of the tape and pulling it off rapidly (not jerked) back upon itself at as close to an angle of 180° as possible. The amount of coating removed from the substrate was evaluated on a standard scale of OB-5B, with 5B indicating good adhesion and OB indicating poor adhesion. Data are shown in Tables 16 and 17.

TABLE 16

| | Coating 1.5 mil on PET (125 μm) | | | | | | | |
|---|---|---|---|---|---|---|---|---|
| | Room Temperature Drying | | | | 120° C. Drying | | | |
| | 1-2 minutes | | | | 2 minutes | | | |
| | Rₛ | | | | Rₛ | | | |
| Ink | (Ohm/sq) | TT % | H % | b* | (Ohm/sq) | TT % | H % | b* |
| 2-IV | 1.73 | 36.5 | 21.90 | 14.34 | 1.74 | 38.4 | 22.20 | 17.14 |
| 2-II | 1.81 | 34.0 | 19.30 | 16.55 | 1.83 | 34.9 | 19.63 | 18.82 |
| 2-III | 1.88 | 37.2 | 17.70 | 15.43 | 1.87 | 38.5 | 18.13 | 17.84 |
| 2-IV | 1.80 | 36.1 | 18.80 | 15.45 | 1.83 | 37.0 | 19.20 | 17.65 |
| 2-V | 1.82 | 42.3 | 18.90 | 13.87 | 1.82 | 44.0 | 19.33 | 15.73 |

TABLE 17

| | | | Adhesion Test | |
|---|---|---|---|---|
| Coating | | | for 120° C. | |
| 1.5 mil | Resistivity ρ, calculated | | Dried Coatings | |
| on PET | (Ohm-cm) | | (3M ® 610 Tape) | |
| (125 μm) | Room | | | After UV |
| Ink | Temp | 120° C. | Before UV | 1.8 J/cm² |
| 2-I | 0.0000164 | 0.0000164 | 0 B | 0 B |
| 2-II | 0.0000171 | 0.0000172 | 0 B | — |
| 2-III | 0.0000177 | 0.0000176 | 0 B | — |
| 2-IV | 0.0000170 | 0.0000173 | 0 B | 5 B |
| 2-V | 0.0000173 | 0.0000172 | 0 B | 5 B |

0 B: Removal of coating beyond area contacted with tape
5 B: No removal or peeling of coating

The data suggest the following:
Different molecular weight HPMC showed similar performance (2-I-through 2-III)
Particular nanoglue (AgF at 3×, lower than previous experiment) did not show positive effect with the high alcohol formulation when AgNW loading is high, but seemed to be a little “worse” with heating
Diacrylate, UV curable, showed similar performance as HPMC in the formulation, although significantly better adhesion was obtained after UV curing.

### Example 7—all Aqueous, High AgNW, with HPMC and Epoxy Blend

This example was carried out to evaluate performance of films formed from inks to which epoxy compounds were added.

Inks 3-i through 3-v were prepared with formulations as shown in Table 18.

TABLE 18

| | AgNW | | Binder | Wetting Agent | |
|---|---|---|---|---|---|
| Ink | (wt %) | Binder | (wt %) | (wt %) | NG |
| 3-i | 2.03 | MC311 | 0.0150 | 0.0060 | 0 |
| 3-ii | 2.03 | MC311 | 0.0150 | 0.0060 | 2x |
| 3-iii | 2.03 | MC311 + D313 | 0.0152 | 0.0060 | 3x |
| 3-iv | 2.03 | MC311 + D321 | 0.0152 | 0.0060 | 3x |
| 3-v | 2.03 | D313 | 0.0015 | 0.0060 | 3x |

Coatings with Inks 3-i through 3-v were prepared by blade coating the inks onto PET-HC using a gap thickness of 1.5 mil. Each coating was first dried at room temperature, and then further treated at 120° C. for up to 2 minutes. For each sample, sheet resistance was measured after each step and resistivity was calculated. Measurements to determine total transmittance, haze and b* were also carried out for each sample. For samples dried at 120° C., an adhesion test was carried out as described for Example 6. Data are shown in Table 19.

TABLE 19

| | Coating 1.5 mil on HC-PET (125 μm) | | | | | | | | |
|---|---|---|---|---|---|---|---|---|---|
| | Room Temperature Drying | | | | 120° C. Drying | | | | |
| | 1-2 minutes | | | | 2 minutes | | | | |
| | Rₛ | | | | Rₛ | | | | |
| Ink | (Ohm/sq) | TT % | H % | b* | (Ohm/sq) | TT % | H % | b* | Adh. |
| 3-i | 1.51 | 25.9 | 19.13 | 10.62 | 1.48 | 25.2 | 19.43 | 11.43 | 0B |
| 3-ii | 1.47 | 26.6 | 24.10 | 8.27 | 1.45 | 26.5 | 24.23 | 9.02 | 0B |
| 3-iii | 1.32 | 23.8 | 26.10 | 8.24 | 1.33 | 24.4 | 26.13 | 9.66 | 0B |
| 3-iv | 1.36 | 24.8 | 25.30 | 8.16 | 1.35 | 24.4 | 25.93 | 9.60 | 0B |
| 3-v | 1.41 | 29.1 | 23.63 | 7.80 | 1.40 | 29.7 | 23.97 | 9.18 | 0B |

0B: Removal of coating beyond area contacted with tape

The data suggest the following:
Use of epoxy compound in combination with HPMC did not improve adhesion, even after heating

### Example 8—High Solid Ink by Evaporation, with UV Curable Resins

This example was carried out in order to obtain very low sheet resistance coatings by concentrating the inks.

Inks 4-1 through 4-V were prepared with formulations as shown in Table 20.

TABLE 20

| | | | | | Wetting | |
|---|---|---|---|---|---|---|
| | AgNW | | Binder | EtOH | Agent | |
| Ink | (wt %) | Binder | (wt %) | (wt %) | (wt %) | NG |
| 4-I | 1.80 | SR9038 | 0.0150 | 77.0 | 0.0060 | 1x |
| 4-II | 1.80 | SR9038 | 0.0150 | 77.0 | 0.0060 | 0 |
| 4-III | 1.80 | SR9038 | 0.0150 | 77.0 | — | 1x |
| 4-IV | 1.80 | SR9038 | 0.0150 | 77.0 | — | 0 |
| 4-V | 1.80 | SR415 | 0.0150 | 77.0 | — | 0 |

Coatings with Inks 4-1 through 4-V were prepared by blade coating the inks onto PET-HC using a gap thickness of 1.5 mil. Each coating was first dried at room temperature, and then further treated at 120° C. for up to 2 minutes. Sheet resistance was measured after each step, and resistivity was calculated. Measurements to determine total transmittance, haze and b* were also carried out for each sample. Data are shown in Table 21.

TABLE 21

| | Coating 1.5 mil on HC-PET (125 μm) | | | | | | | |
|---|---|---|---|---|---|---|---|---|
| | Room Temperature Drying | | | | 120° C. Drying | | | |
| | 1-2 minutes | | | | 2 minutes | | | |
| | Rₛ | | | | Rₛ | | | |
| Ink | (Ohm/sq) | TT % | H % | b* | (Ohm/sq) | TT % | H % | b* |
| 4-I | 2.17 | 44.8 | 17.20 | 14.33 | 2.15 | 45.7 | 17.90 | 17.01 |
| 4-II | 2.20 | 43.0 | 15.40 | 15.66 | 2.21 | 44.1 | 15.70 | 17.61 |
| 4-III | 2.12 | 44.0 | 17.40 | 14.91 | 2.03 | 45.7 | 17.70 | 17.38 |
| 4-IV | 2.04 | 39.5 | 16.50 | 15.00 | 2.01 | 41.4 | 16.60 | 17.26 |
| 4-V | 2.18 | 43.0 | 15.20 | 14.26 | 2.15 | 43.9 | 15.40 | 16.22 |

The above inks were concentrated by removal of EtOH, and the resulting inks were coated by blade coating onto PET-HC using a gap thickness of 1 mil and room temperature drying. Sheet resistances were measured and resistivity was calculated. Data are shown in Table 22.

TABLE 22

| After partial | | | | |
|---|---|---|---|---|
| removal of alcohol | | Coating 1 mil on HC-PET (125 μm) | | |
| solvent | | Room Temperature Drying, 2 min | | |
| Conc. | Solids | Rₛ | ρ | Rₛ |
| Ink | (wt %) | (Ohm/sq) | (Ohm-cm) | (Ohm/sq/mil) |
| 4-I′ | 7.48 | 0.92 | 0.0000190 | 0.0075 |
| 4-II′ | 10.06 | 0.70 | 0.0000195 | 0.0077 |
| 4-III′ | 8.98 | 0.81 | 0.0000201 | 0.0079 |
| 4-IV′ | 7.02 | 0.73 | 0.0000142 | 0.0056 |
| 4-V′ | 7.06 | 0.92 | 0.0000180 | 0.0071 |

The data suggest the following:
Triacrylate SR415 behaved similarly as SR9038, a diacrylate, in ink performance
Concentrated inks may be obtained for achieving very low sheet resistances

Table 23 gives the rheology results of the concentrated inks 4-I′ through 4-V. As can be seen the concentrated inks show shear thinning behavior.

TABLE 23

| | Inks of Set 4 of | | | | | |
|---|---|---|---|---|---|---|
| | Experiments | | | | | |
| | Ag | Solids | ρ | Viscosity (cPs) | | |
| Conc. Ink | (wt %) | (wt %) | (Ohm-cm) | 1 s⁻¹ | 10 s⁻¹ | 100 s⁻¹ |
| 4-I′ | 6.46 | 7.48 | 0.0000190 | 9565 | 1763 | — |
| 4-II′ | 8.68 | 10.06 | 0.0000195 | 9565 | 1626 | — |
| 4-III′ | 7.75 | 8.98 | 0.0000201 | 10865 | 1599 | — |
| 4-IV′ | 6.06 | 7.02 | 0.0000142 | 5126 | 782 | 146 |
| 4-V′ | 6.09 | 7.06 | 0.0000180 | 5346 | 785 | 150 |

### Example 9—High Solid Ink by Evaporation, with UV Curable Resins and Use of Photoinitiator

Inks 6-a through 6-f were prepared with formulations as shown in Table 24. Results are summarized in Table 25.

TABLE 24

| | | | | | | PI |
|---|---|---|---|---|---|---|
| | AgNW | | Resin | | | Irgacure 754 |
| Ink | (wt %) | Resin | (wt %) | EtOH | NG | (wt %) |
| 6-a | 1.80 | SR9038 | 0.0375 | 77 | — | — |
| 6-b | 1.80 | SR9038 | 0.0750 | 77 | — | — |
| 6-c | 1.80 | SR415 | 0.0375 | 77 | — | — |
| 6-d | 1.80 | SR415 | 0.0750 | 77 | — | — |
| 6-e | 1.35 | SR9038 | 0.0375 | 58 | — | — |
| 6-f | 1.80 | SR9038 | 0.0750 | 77 | — | 0.0113 |

TABLE 25

| Coating | |
|---|---|
| 1.5 mil on HC-PET | Room Temperature Drying |

| (125 μm) | Rₛ | % | % | |
|---|---|---|---|---|
| Ink | (Ohm/sq) | TT | H | b* |
| 6-a | 2.14 | 44.3 | 16.20 | 14.63 |
| 6-b | 2.30 | 47.9 | 15.20 | 14.99 |
| 6-c | 2.30 | 47.5 | 14.83 | 13.81 |
| 6-d | 2.27 | 48.1 | 15.73 | 14.29 |
| 6-e | 3.06 | 57.9 | 13.40 | 11.21 |
| 6-f | 2.36 | 49.2 | 15.43 | 15.54 |

The above inks were concentrated by removal of EtOH, and the resulting inks were coated by blade coating onto PET-HG using a gap thickness of 3 mil and room temperature drying with a heat gun for 2 minutes. Sheet resistances were measured and resistivity and sheet resistance per mil thickness were calculated. Data are shown in Table 26.

TABLE 26

| After partial | | Coating 3 mil blade on PET (125 μm) | | |
|---|---|---|---|---|
| removal of alcohol | | Room Temperature, Heat Gun, 2 minutes | | |
| solvent | | | ρ, | Rₛ, |
| | Solids | Rₛ | calculated | calculated |
| Ink | (wt %) | (Ohm/sq) | (Ohm-cm) | (Ohm/sq/mil) |
| 6-a′ | 6.48 | 0.36 | 0.0000196 | 0.0077 |
| 6-b′ | 6.86 | 0.36 | 0.0000218 | 0.0086 |
| 6-c′ | 6.35 | 0.40 | 0.0000213 | 0.0084 |
| 6-d′ | 6.65 | 0.37 | 0.0000217 | 0.0085 |
| 6-e′ | 6.29 | 0.56 | 0.0000296 | 0.00117 |
| 6-f′ | 6.01 | 0.45 | 0.0000238 | 0.0094 |

The data suggest the following:
Triacrylate SR415 showed better performance in improving UV curing and adhesion
Use of photoinitiator can further help curing and adhesion after UV cure
Concentrated inks (6-a′ through 6-f′) can give very low sheet resistances even with low temperature drying

Table 27 gives the rheology results of the concentrated inks 6-a′ through 6-f′.

TABLE 27

| | Inks of Set 6 of | | | | | |
|---|---|---|---|---|---|---|
| | Experiments | | | | | |
| Conc. | Ag | Solids | ρ | Viscosity (cPs) | | |
| Ink | (wt %) | (wt %) | (Ohm-cm) | 1 s⁻¹ | 10 s⁻¹ | 100 s⁻¹ |
| 6-a′ | 5.54 | 6.48 | 0.0000196 | 2778 | 377 | 71.4 |
| 6-b′ | 5.76 | 6.86 | 0.0000218 | 5953 | 694 | 117 |
| 6-c′ | 5.42 | 6.35 | 0.0000213 | 8731 | 913 | 177 |
| 6-d′ | 5.58 | 6.65 | 0.0000217 | 7541 | 615 | 131 |

### Example 10—Inks with Varied Resin and PI Concentrations

Inks 8-1 to 8-4 were prepared with formulations as shown in Table 28.

TABLE 28

| | | | | PI | PI to |
|---|---|---|---|---|---|
| | AgNW | | Resin | Irg. 2959 | Resin |
| Ink | (wt %) | Resin | (wt %) | (wt %) | (%) |
| 8-1 | 1.80 | SR415 | 0.0375 | 0.00375 | 10.0 |
| 8-2 | 1.80 | SR415 | 0.0750 | 0.00750 | 10.0 |
| 8-3 | 1.80 | SR415 | 0.0750 | 0.00375 | 5.0 |
| 8-4 | 1.80 | SR415/SR740A | 0.0750 | 0.00750 | 10.0 |

The above inks were concentrated by removal of EtOH, and the resulting inks were coated by blade coating onto PET-HG. Sheet resistances and resistivities were measured after drying at room temperature and after UV curing and data are shown in Table 29.

TABLE 29

| | | Rₛ (Ohm/sq) | | | ρ (Ohm-cm) | |
|---|---|---|---|---|---|---|
| Conc. | Solids | RT | | Thickness | RT | After |
| Ink | (wt %) | Drying | UV Cure | (cm) | Dry | UV |
| 8-1′ | 15.76 | 0.165 | 0.155 | 0.000110 | 0.0000181 | 0.0000170 |
| 8-2′ | 15.12 | 0.176 | 0.173 | 0.000112 | 0.0000197 | 0.0000194 |
| 8-3′ | 14.81 | 0.173 | 0.173 | 0.000110 | 0.0000190 | 0.0000190 |
| 8-4′ | 16.72 | 0.176 | 0.165 | 0.000124 | 0.0000218 | 0.0000205 |

Table 30 gives the rheology results of the concentrated inks 8-1′ through 8-4′.

TABLE 30

| | Inks of Set 8 of | | | | | |
|---|---|---|---|---|---|---|
| | Experiments | | | | | |
| | Ag | Solids | ρ | Viscosity (cPs) | | |
| Conc. Ink | (wt %) | (wt %) | (Ohm-cm) | 1 s⁻¹ | 10 s⁻¹ | 100 s⁻¹ |
| 8-1′ | 13.8 | 15.76 | 0.0000170 | 17264 | 3532 | 704 |
| 8-2′ | 13.0 | 15.12 | 0.0000194 | 14288 | 3453 | 601 |
| 8-3′ | 12.7 | 14.81 | 0.0000190 | 18653 | 3751 | 643 |
| 8-4′ | 14.4 | 16.72 | 0.0000205 | 17661 | 3235 | 681 |

The data suggest the following:
Triacrylate SR415 at various levels or combination with diacrylate SR740A did not show large variations but lower binder use leads to lower calculated resistivity

Inks 8-1′ through 8-4′ were coated at different thicknesses by coating with multiple passes up to 10 passes. Coating quality was visually assessed and evaluated as follows with results summarized in Table 31:
a=almost everything removed
b=mixed failure—large holes
c=mixed failure—small holes
d=mostly cohesive failure

TABLE 31

Sample

| | | | |
|---|---|---|---|
| 8-1′ | 8-2′ | 8-3′ | 8-4′ |

| | |
|---|---|
| Passes | Appearance |

| | | | | |
|---|---|---|---|---|
| 0 | a | a | a | a |
| 1 | b | b | b | b |
| 3 | b | b | c | c |
| 6 | b | b | c | c |
| 9 | b | d | d | d |
| 15 | b | d | d | d |
| 25 | c | d | d | d |
| 40 | d | d | d | d |

The data suggest:
There were no obvious changes in adhesion at the coated thicknesses. In general, the lower binder use is not beneficial for cohesion improvement

### Further Inventive Concepts

A1. An ink for forming an electrically conductive deposit comprising an aqueous solvent and at least about 3 wt % metal particulates comprising at least about 67 wt % silver nanowires, wherein the ink is stable against visible settling for at least 24 hours without agitation.
A2. The ink of inventive concept A1 comprising at least about 5 wt % silver particulates.
A3. The ink of inventive concept A1 comprising from about 3 wt % to about 20 wt % metal particulates.
A4. The ink of inventive concept A1 wherein the silver particulates comprise at least about 90 wt % silver nanowires.
A5. The ink of inventive concept A1 further comprising from about 3 wt % to about 25 wt % nonvolatile organic material.
A6. The ink of inventive concept A1 wherein the ink comprises up to about 20 wt % metal particulates and from about 2 wt % to about 25 wt % nonvolatile organics.
A7. The ink of inventive concept A1 wherein the ink comprises from about 2 wt % to 20 wt % polyvinylpyrrolidone relative to a total weight of the silver nanowires.
A8. The ink of inventive concept A7 wherein the nonvolatile organics comprise at least about 50 wt % polyvinylpyrrolidone.
A9. The ink of inventive concept A1 wherein the ink further comprises silver ions or complexes in a concentration from about 0.005 mg/mL to about 50.0 mg/mL.
A10. The ink of inventive concept A9 wherein the aqueous solvent comprises at least about 80 wt % water.
A11. The ink of inventive concept A9 wherein the ink forms a conductive material upon removal of the aqueous solvent.
A12. The ink of inventive concept A6 wherein the nonvolatile organics comprise a polysaccharide, a polyacrylate precursor or a mixture thereof.
A13. The ink of inventive concept A6 wherein the nonvolatile organic compounds comprise a curable resin
A14. The ink of inventive concept A9 wherein the solvent further comprises a volatile alcohol.
A15. The ink of inventive concept A6 wherein the nonvolatile organics comprise polymer precursors comprising monomers, oligomers, liquid or solid dissolved polymers, or mixtures thereof that form upon drying and curing a polyethylene terephthalate (PET), polyethylene naphthalate (PEN), polyacrylate, poly(methyl methacrylate), polyamide, polyimide, polysiloxane, polyester, epoxy, polyurethane, polyvinyl alcohol, polyvinyl acetate, copolymers thereof, or blends.
A16. The ink of inventive concept A6 having non-Newtonian rheology.
B1. A method for forming an ink for forming an electrically conductive deposit, the method comprising:
   forming a good solvent blend dispersion of silver nanowires having a concentration of no more than about 2.5 wt %, wherein the solvent comprises at least about 20 volume percent alcohol with a boiling point of no more than about 99° C.; and
   removing solvent to concentrate the good solvent blend dispersion to form an aqueous dispersion having at least about 3 wt % silver nanowires.
B2. The method of inventive concept B1 wherein the solvent of the good solvent blend comprises ethanol, isopropyl alcohol or a mixture thereof.
B3. The method of inventive concept B1 wherein the good solvent blend dispersion of silver nanowires has a concentration of silver nanowires from about 1.5 wt % to about 2.1 wt %.
B4. The method of inventive concept B1 wherein the good solvent blend dispersion is stable against any significant settling for at least 3 months in a sealed environment preventing solvent evaporation or contamination.
B5. The method of inventive concept B1 wherein removing the solvent comprises application of a negative pressure to facilitate evaporation of the solvent.
B6. The method of inventive concept B1 wherein removing the solvent comprises application of heat to facilitate evaporation of the solvent.
B7. The method of inventive concept B1 further comprising adding a selected amount of water prior to the removing the solvent step.
B8. The method of inventive concept B7 wherein removal of the solvent provides an aqueous silver nanowire dispersion with a selected concentration of silver nanowires.
B9. The method of inventive concept B1 further comprising
   adding polymer binder precursors to the aqueous dispersion to form a coatable ink.
B110. The method of inventive concept B9 wherein the polymer binder precursors comprise monomers, oligomers, or resin which in pure form are liquids.
B111. The method of inventive concept B9 wherein the polymer binder precursors comprise dissolved polymers that solids in pure form.
B12. The method of inventive concept B9 further comprising adding additional silver particulates to the aqueous dispersion.
B113. The method of inventive concept B9 wherein the coatable ink is any one of the inks of claims 22 to 37.
C1. A method for forming an electrically conductive composite material, the method comprising:
   casting an ink comprising a solid content that has from about 75 wt % to about 98 wt % silver particulates and least about 2 wt % polymer binder precursors, wherein the silver particulates comprise at least about 67 wt % silver nanowires having an aspect ratio of at least about 75, to form a casted structure and
   curing the cast structure to form the electrically conductive composite material.
C2. The method of inventive concept C1 wherein the curing is performed at room temperature.
C3. The method of inventive concept C1 wherein the curing is performed at temperatures of no more than about 100° C.
C4. The method of inventive concept C1 wherein the curing consists of solvent removal.
C5. The method of inventive concept C1 wherein curing comprises UV irradiation to crosslink a polymer binder.
C6. The method of inventive concept C1 wherein curing comprises crosslinking a polymer binder.
C7. The method of inventive concept C1 wherein casting comprises slot coating of the ink onto a substrate.
C8. The method of inventive concept C1 wherein casting comprises dip coating, spray or jet-deposition, or screen printing.
C9. The method of inventive concept C1 wherein the ink is the ink of any one of the inks of claims 22-37.
C10. The method of inventive concept C1 wherein the electrically conductive material is the electrically conductive material of any one of claims 1-10.
C11. The method of inventive concept C10 wherein the cast structure after curing is any one of the electrically conductive structures of claims 11-21.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. An electrically conductive composite material comprising from about 75 wt % to about 98 wt % silver particulates and least about 2 wt % polymer binder, wherein the silver particulates comprise at least about 67 wt % silver nanowires having an aspect ratio of at least about 75.

2. The electrically conductive composite material of claim 1 having a resistivity of no more than about 5×10⁻³ Ohm-cm.

3. The electrically conductive composite material of claim 1 having a resistivity of no more than about 5×10⁻⁴ Ohm-cm.

4. The electrically conductive composite material of claim 1 wherein the composite material has at least about 25 vol % silver.

5. The electrically conductive composite material of claim 1 wherein the polymer binder comprises a polysaccharide.

6. The electrically conductive composite material of claim 1 wherein the polymer binder comprises a polyethylene terephthalate (PET), polyethylene naphthalate (PEN), polyacrylate, poly(methyl methacrylate), polyamide, polyimide, polysulfone, polysiloxane, polyester, epoxy, polyurethane, polyvinyl alcohol, polyvinyl acetate, copolymers thereof, or blends of polymers.

7. The electrically conductive composite material of claim 1 wherein the composite material consists essentially of the discrete silver particulates, the polymer binder and no more than about 2 wt % crosslinking agents and/or viscosity modifiers.

8. The electrically conductive composite material of claim 1 wherein the silver nanowires have an average diameter from about 15 nm to about 80 nm and an aspect ratio from about 100 to about 1500.

9. The electrically conductive composite material of claim 1 wherein the silver particulates comprise at least about 90 wt % nanowires.

10. The electrically conductive composite material of claim 1 comprising at least about 90 wt % silver particulates.

11. An electrically conductive structure comprising the electrically conductive composite material of claim 1 and having a transmittance of visible light of no more than about 70%.

12. The electrically conductive structure of claim 11 wherein the electrically conductive structure comprises a layer having an average thickness of from about 0.2 microns to about 2 millimeters.

13. The electrically conductive structure of claim 11 wherein the electrically conductive structure comprises a layer having an average thickness of no more than about 5 microns and a sheet resistance of no more than about 5 Ohms/sq.

14. The electrically conductive structure of claim 11 wherein the electrically conductive structure comprises an opaque layer having an average thickness of no more than about microns and a sheet resistance of no more than about 1 Ohms/sq.

15. The electrically conductive structure of claim 11 wherein the electrically conductive structure comprises a layer comprising at least about 90 wt % silver particulates and wherein the silver particulates comprise at least about 90 wt % silver nanowires.

16. The electrically conductive structure of claim 11 wherein the electrically conductive composite material has a resistivity of no more than about 5×10⁻⁴ Ohm-cm.

17. The electrically conductive structure of claim 11 wherein the composite does not have deposits of in situ reduced metal.

18. The electrically conductive structure of claim 11 wherein the electrically conductive structure comprises the electrically conductive composite material disposed on a heat sensitive substrate unstable over about 100° C.

19. The electrically conductive structure of claim 11 wherein the electrically conductive composite material is in the form of an electrical interconnect.

20. The electrically conductive structure of claim 11 wherein the electrically conductive structure (composite material) is processed at temperatures below about 100 C.

21. The electrically conductive structure of claim 11 wherein the electrically conductive composite material is disposed on a substrate in roll form.
